(19) United States
(12) Patent Application Publication
(10) Pub. No.: US 2014/0183395 A1
(43) Pub. Date: Jul. 3, 2014

(54) Rotary Ceramic Valve

(71) Applicant: Midwest Sealing Products, Inc., Buffalo Grove, IL (US)

(72) Inventors: Robert C. Popke, Hawthorn Woods, IL (US); William S. Sankey, West Allis, WI (US)

(21) Appl. No.: 14/138,873

(22) Filed: Dec. 23, 2013

Related U.S. Application Data
(60) Provisional application No. 61/745,040, filed on Dec. 21, 2012.

(51) Int. Cl. F16K 39/00

(52) U.S. Cl. CPC F16K 39/00
USPC 251/283

(57) ABSTRACT

A rotary ceramic tube valve is disclosed. The valve may have an outer shell and an inner ported cylinder which move in relation to each other of open and close ports on the valve. By turning the inner ported cylinder in relation to the outer shell, different orifices in the outer tube may be opened or closed. By coating the inner surface of the outer tube and the outer surface of the inner ported cylinder with a ceramic coating, friction in the valve may be reduced resulting in longer life, less heat generation, tighter tolerances and more reliable long term operation. Further, inner rotor 200 may also have cylindrical pressure balancing seals and related pressure communicating paths that provide counterforce to reduce stress on the bearings.

### BACKGROUND

Valves that can withstand great pressure and not lose pressure when moving from open to closed positions are difficult to design and build. High pressure creates high stress on moving parts which results in high temperatures, extra wear and a shorter life span. In addition, the high pressure makes leaks even more problematic in that even a small leak can result in large losses in pressure and material flowing through the valve.

### SUMMARY

A rotary ceramic valve is disclosed. The valve may have an outer tube/body and an inner ported cylinder/rotor which move in relation to each other to open and close ports on the valve. The outer tube/body includes a plurality of outer orifices or ports that correspond to inner orifices in an inner cylinder/rotor, a seal seat adapted accept a seal wherein the seal separates chambers inside the tube/rotor, a first bearing seat adapted to accept a first bearing for the inner cylinder, a second bearing seat adapted to accept a second bearing for the inner cylinder/rotor, a first closure adapted to seal a first end of the outer tube/body and a second closure adapted to seal a second end of the outer tube/body and adapted permit a turning apparatus to protrude to allow the inner cylinder/rotor to be rotated. The inner surface of the outer tube/body may be coated with a ceramic coating.

The inner cylinder/rotor may include a plurality of inner orifices that correspond to outer orifices in the outer tube/body and a spindle that corresponds to the first bearing and second bearing and is in communication with the turning apparatus adapted to turn the inner cylinder/rotor. The outer surface of the inner cylinder/rotor may be coated with a ceramic coating.

The outer orifices may include a first orifice facing a first plane at a first height, a second orifice facing the first plane and being at a second height and a third orifice facing opposite the first plane and being at a third height where the first height, second height and third height are at different heights. The first orifice, second orifice and third orifice are separated by seals wherein the seals define a first chambers related to the first orifice, a second chamber related to the second orifice and a third chamber related to the third orifice.

The inner ported cylinder/rotor may include a first cylinder port facing the first plane at the first height, a second cylinder port facing the first plane at the second height, a third cylinder port facing opposite the first plane at the second height and a fourth cylinder port facing opposite the first plane at the third height.

In operation, aligning the first orifice and first cylinder port also aligns the second orifice and the second cylinder port and, aligning the third orifice and the third cylinder port also aligns the second orifice with the second cylinder orifice. If the first orifice and first cylinder port are not aligned, the first orifice is closed, if the second orifice and second cylinder port are not aligned, the second orifice is closed and if the third orifice and third cylinder port are not aligned, the third orifice is closed.

In another embodiment, the inner ported rotor may have a single plane of ports and the outer tube/body may also have a corresponding single plane of orifices. The ports in the inner ported rotor may be in communication and may be separated by around 132 degrees. By rotating the inner rotor, the first, second and third orifices may be sealed or be in communication in virtually any combination.

The inner cylinder/rotor may also have cylindrical pressure balancing seals that provide counterforce to reduce stress on the bearings. A first orifice on a first side may communicate pressure to a cylindrical pressure balancing seal opposite the first side. Similarly, a second orifice on a second side may communicate pressure to a cylindrical pressure balancing seal opposite the second side and a third orifice on a third side may communicate pressure to a cylindrical pressure balancing seal opposite the third side.

### BRIEF DESCRIPTION OF THE DRAWINGS

FIG. 1 illustrates an outer tube/body of the valve assembly;

FIG. 2 illustrates the outer tube/body assembly rotated 90 degrees from FIG. 1 with an inner ported cylinder/rotor;

FIG. 3 illustrates the outer tube/body of the valve assembly rotated an additional 90 degree from FIG. 2;

FIG. 4 illustrates the outer tube/body of the valve assembly with a bearing and the inner ported cylinder/rotor in a closed position;

FIG. 5 illustrates a cutaway view of the outer tube/body valve assembly with the inner ported cylinder/rotor in a closed position;

FIG. 6 illustrates the outer tube/body of the valve assembly with the bearing and the inner ported cylinder in a first open position;

FIG. 7 illustrates a cutaway view of the outer tube/body of the valve assembly with the inner ported cylinder in the first open position;

FIG. 8 illustrates the outer tube/body of the tube valve assembly with the end cap and the inner ported cylinder in a second open position;

FIG. 9 illustrates a cutaway view of the outer tube of the tube valve assembly with the inner ported cylinder in the second open position;

FIG. 10 illustrates a solid inner ported cylinder with tubes connecting the ports;

FIG. 11 illustrates an additional embodiment of the tube valve in a single plane;

FIG. 12 illustrates the additional embodiment of the tube valve;

FIG. 13 is an additional view of the additional embodiment of the tube valve;

FIG. 14 is an illustration of the flow path through the outer tube/body in the additional embodiment of the tube valve;

FIGS. 15a and 15b are illustrations of the outer tube in the additional embodiment of the tube valve;

FIGS. 16a and 16b are illustrations of the inner tube in the additional embodiment of the tube valve;

FIGS. 17a and 17b are additional illustrations of the inner tube in the additional embodiment of the tube valve;

FIG. 18 is a cut away illustration of the inner tube in the additional embodiment of the tube valve;

FIGS. 19a and 19b are illustrations of a cylindrical pressure balancing seal;

FIG. 20 is an illustration of a cylindrical pressure balancing seal;

FIG. 21 is an illustration of a valve in a rectangular body;

FIGS. 22a, 22b and 22c are illustrations of the valve from a variety of orientations;

FIG. 23 is an overhead view of the valve;

FIG. 24 is an illustration of the valve in a round body;

FIG. 25 is an overhead cut-away view of the valve with the inner tube/rotor in a block position;

FIGS. 26a and 26b are illustrations of the valve illustrating a spherical port seal and the cylindrical pressure balancing seal;

FIG. 27 is an illustration of a spherical port seal;

FIG. 28 is an illustration of a cylindrical pressure balancing seal;

FIGS. 29a 29b and 29c are illustrations of a cap and cylindrical pressure balancing seal;

FIGS. 30a and 30b are illustrations of a top view of the cap and cylindrical pressure balancing seals;

FIG. 31 is an illustration of the rotor populated with pressure balancing seals and spherical port seals;

FIG. 32 is a cut-away view of another embodiment of the valve;

FIG. 33a is a cut-away view of an embodiment of the valve;

FIG. 33b is a detailed view of a cylindrical pressure balancer in the valve;

FIGS. 34a, 34b and 34c are illustrations of the valve in a smaller form from a variety of orientations;

FIG. 35a is an illustration of the pressure balancing channels of the valve;

FIG. 35b is an illustration of an inlet into the valve body;

FIG. 35c is an illustration of an encoder attaching to the rotor;

FIG. 36a is a cutaway illustration of a valve body;

FIG. 36b is an illustration of a valve inlet and spherical port seal;

FIG. 37a is an overhead cutaway view of the valve and inner rotating body;

FIG. 37b is an illustration of the valve body with a valve inlet;

FIG. 38a is illustration of the inner tube/rotor with pressure balance features;

FIG. 38b is an overhead view of the inner tube/rotor and valve inlet seals interfacing with the inner tube;

FIGS. 39a and 39b are illustrations of the cylindrical pressure balancing seals that are mounted on trunnions;

FIGS. 40a and 40b are cutaway illustrations of the cylindrical pressure balancing seals;

FIG. 41a is an overhead cutaway view of the pressure balancing features of the pressure balancing seals on trunnions;

FIG. 41b is an overhead cutaway view of the pressure balancing feature and pressure path of the cylindrical pressure balancing seals mounted on trunnions;

FIG. 42a is an opaque view of the valve cap, cylindrical pressure balancing seals mounted on trunnions and pressure balancing path of the valve cap;

FIG. 42b is an opaque view of the valve cap, cylindrical pressure balancing seals mounted on trunnions and pressure balancing path; and

FIG. 43 is a cutaway view of the valve cap, cylindrical pressure balancing seals mounted on trunnions and pressure balancing path.

### SPECIFICATION

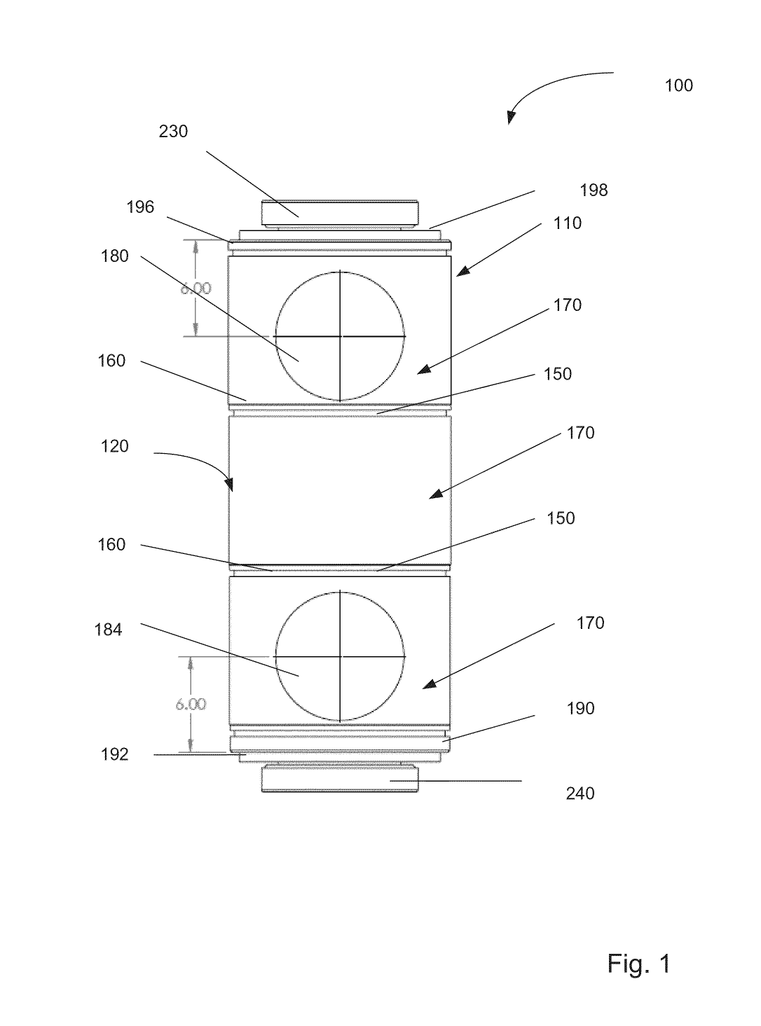

Referring to FIG. 1, a rotary ceramic valve 100 is disclosed. The valve 100 may be capable of withstanding great pressure, even at a large scale, but still provide long life. Previous valves such as slide valves may be able to be effective at a large size but did not provide the desired control and lost pressure as the valve was actuated. Further, slide valves may have limited life due to friction and pressure.

In one embodiment, the ceramic valve 100 may have an outer tube or body 110 and an inner ported rotor or cylinder 200. By turning the inner ported cylinder 200 in relation to the outer tube 110, different orifices in the outer tube may be opened or closed. By coating the inner surface 120 of the outer tube 110 and the outer surface 210 of the inner ported cylinder 200 with a ceramic coating and holding the inner ported cylinder in pace with thrust bearings, friction in the valve 100 may be reduced resulting in longer life, less heat generation, tighter tolerances and more reliable long term operation.

The coating may be a rod-form ceramic coating. In some embodiments, the coating may be molten, flamed-sprayed ceramic resulting in high particle-to-particle cohesive bonding. The rod-form process may deliver ceramic to the substrate with high kinetic energy and thermal mass for higher particle-to-particle cohesive bonding. In addition, heat transfer may be 50% lower than with other application methods which may avoid warp-age or distortion due to heat. In other embodiments, the coating may be a powder based coating.

The outer tube or body 110 may be made from a variety of materials depending on the intended use. In some embodiments, the intended use may result in significant pressure being applied to the valve 100. In such embodiments, the material may be high strength carbon steel. In other less stressful embodiments, other materials may be used. The shape of the outer tube 110 is illustrated as being round but other shapes may be accommodated so long as the inner ported cylinder 200 has a complementary shape. In some embodiments, the pressure on the valve 100 may make a round shape more likely while in embodiments with less pressure, other shapes may be possible.

The outer tube 110 may have a seal seat 150. The seal seat 150 may be adapted accept a seal 160 wherein the seal 160 separates chambers 170 inside the tube 110. The seal seat 150 may be a simple channel in the outer tube 110 or may be shaped to lock the seal 160 in place by briefly deforming the seal 160 to securely fit in the seal seat 150. There may be a plurality of seals seats 150 and seals 160 as there may be a plurality of chambers 170. The number of chambers 170 may relate to the number of orifices in the outer tube as any fluid or gas in each chamber 170 may be kept separate from the fluid or gas in the other chambers 170. Even with the tight tolerances that are possible with the coated surfaces, matter such as fluid or gas still may enter the area around between the outer tube 110 and the inner cylinder 200 and the seals 160 may keep the fluid from passing from one chamber to another. In the embodiment in FIG. 1, there may be three chambers 170 as there are three orifices or ports 180, 182, 184 and there may be two seal seats 150 and two seals 160 to separate the three chambers 170. Of course, in another embodiment, the seal seat 150 may be part of the inner ported cylinder and the seal 160 may sit in the seal seat 150.

The orifices 180, 182, 184 may be any logical shape that can accept complementary connections. In some embodiments, the orifices 180, 182, 184 may be round but other shapes are possible and are contemplated. Connections may be made to the orifices 180, 182, 184 using threads, fitments, bushings or any other logical connection manners.

The outer tube 110 may also have a first bearing seat 190 adapted to accept a first bearing 192 for the inner cylinder and a second bearing seat 196 adapted to accept a second bearing 198 for the inner ported cylinder 200. The bearings 192 198 may be thrust bearings to ensure proper control. Like other bearings, thrust bearing permit rotation between parts, but they are designed to support a high axial load. If the force on the bearing 192 198 is significant, thrust bearings may be necessary while if the force on the bearing 192 198 is less, other bearings may be used. The bearing seats 190 196 may be shaped to accept the bearing 192 198 selected.

The outer tube 110 may include a first closure 240. The first closure 240 may be adapted to seal a first end of the outer tube 110. The first closure 240 may be similar to a cap to close the outer tube 110. The material used to create the first closure 240 may be a material that is compatible with the outer tube 110 and the environment of use for the valve 100. The manner of attaching the first closure 240 may depend on the environment the valve 100 will be used. For example, if the valve will be subjected to extreme pressure such as in a hydraulic situation, the manner of attaching the first closure 240 may be different than if the valve 100 is used in a less pressure filled environment. Other factors may include the material of the outer tube 110, the material being subjected to the valve 100, the danger a leak from the first closure 240 may cause, etc. In some embodiments, the first closure 240 may be threaded and may be threaded onto the outer tube 110. In other embodiments, the first closure 240 may be bolted onto the outer tube 110. Of course, other manners of attaching the first closure 240 are possible and are contemplated.

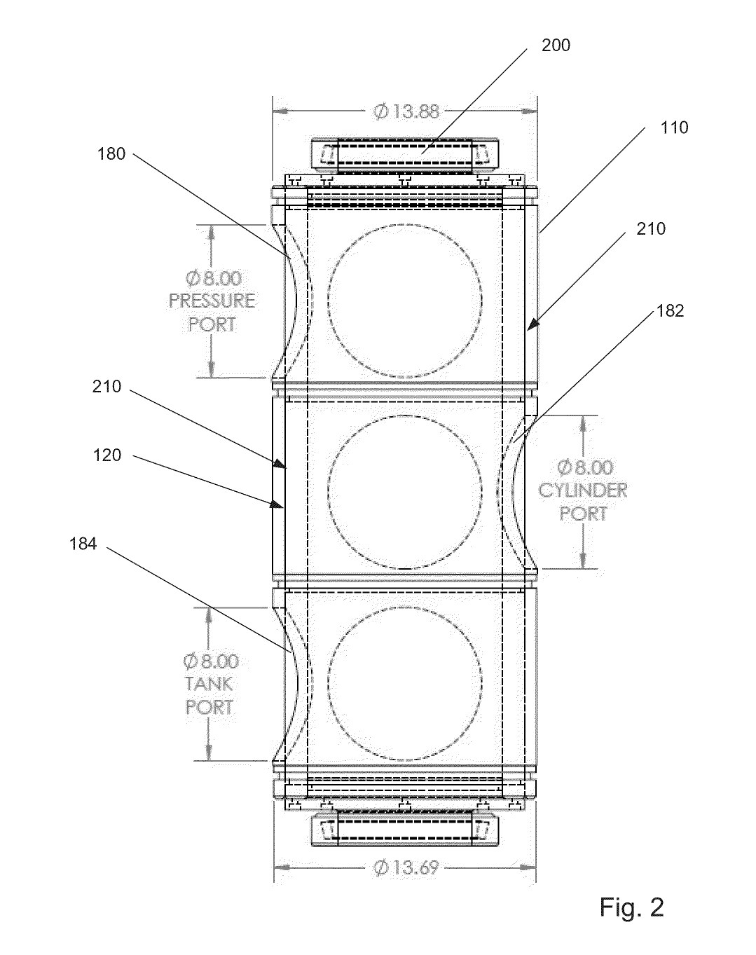

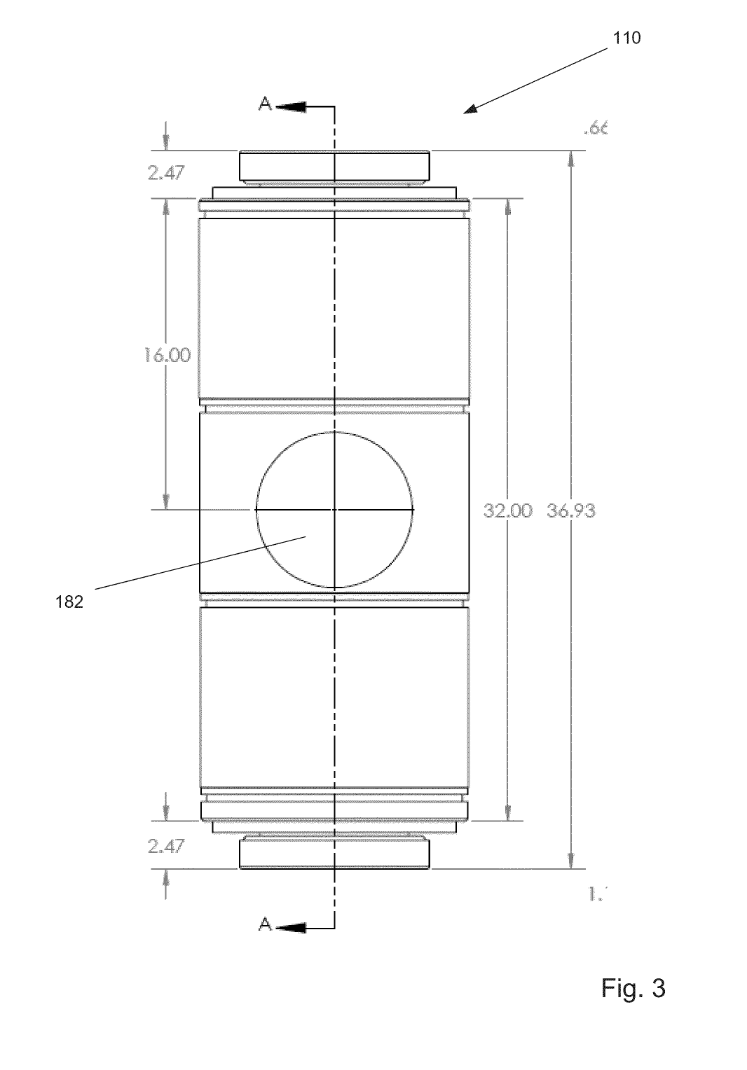

The outer tube 110 may also include a second closure 250 to seal a second end or an end opposite of the first closure 240. The second closure 250 may be adapted to seal a second end of the outer tube 110 and may also be adapted permit a turning apparatus 270 (FIG. 2) to protrude to allow the inner ported cylinder 200 to be rotated. Similar to the first closure 240, the material used to create the second closure 250 may be a material that is compatible with the outer tube 110 and the environment of use for the valve 100. The manner of attaching the second closure 250 may depend on the environment the valve 100 will be used. For example, if the valve 100 will be subjected to extreme pressure such as in a hydraulic situation, the manner of attaching the second closure 250 may be different than if the valve 100 is used in a less pressure filled environment. Other factors may include the material of the outer tube 110, the material being subjected to the valve 100, the danger a leak from the second closure 250 may cause, etc. In some embodiments, the second closure 250 may be threaded and may be threaded onto the outer tube 110. In other embodiments, the second closure 250 may be bolted onto the outer tube 110. Of course, other manners of attaching the second closure 250 are possible and are contemplated. In an additional embodiment, the outer tube 110 may be made such that one end is closed at the time of manufacture, eliminating the need for the first closure 240.

The turning apparatus 270 may be a variety of shapes and designs. In some embodiments, a shaft or spindle 270 that attaches to the inner ported cylinder 200 may protrude through the second closure 250 where it may be turned by another device such as a step motor or through a gear system in communication with a motor. In another embodiment, such as the embodiment illustrated in FIG. 2, a collar that is in communication with the inner ported cylinder 200 may act as the turning apparatus 270. Of course, a variety of different turning apparatuses 270 are possible and are contemplated.

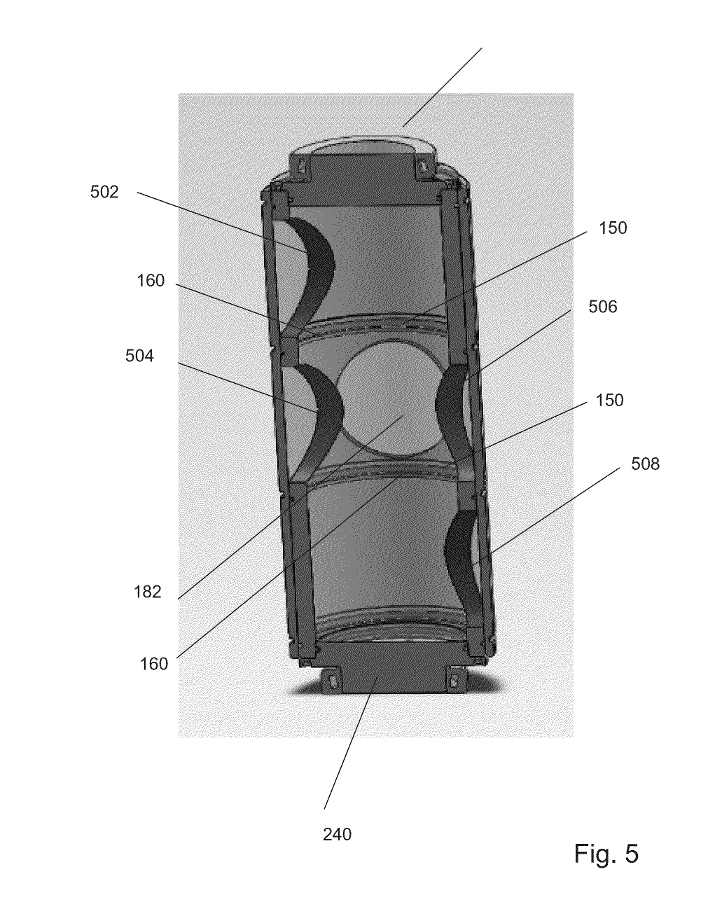

The inner ported cylinder 200 may be hollow and may include a plurality of inner ports 502, 504, 506, 508 (FIG. 5) that correspond to outer orifices 180, 182, 184 in the outer tube 110. The ports 502, 504, 506, 508 may be a variety of shapes but it may be desirable to have the shape of the ports 502, 504, 506, 508 match the shape of the corresponding orifice 180, 182, 184. In operation, turn the inner ported cylinder 200 may result in the inner ports 502, 504, 506, 508 lining up with the orifices 180, 182, 184 in the outer tube 110, resulting in flow through the lined up orifice 180, 182, 184.

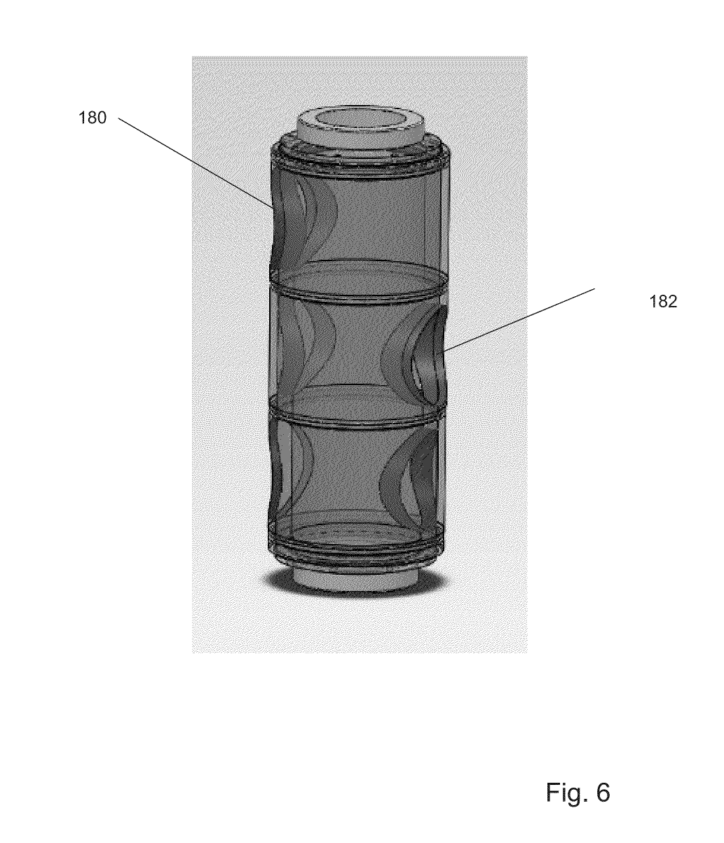

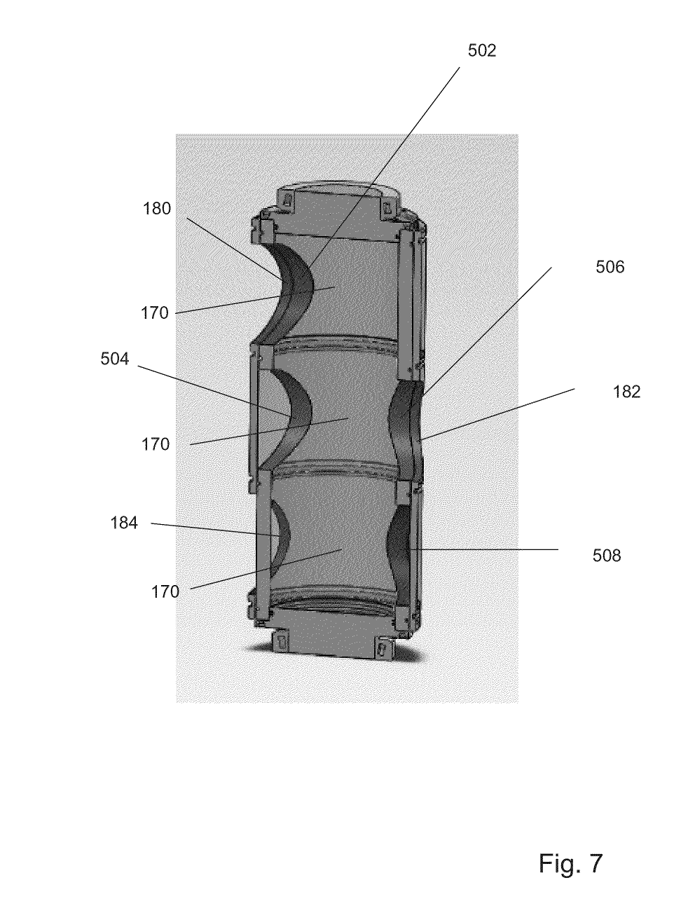

In one embodiment, in the outer tube 110, the first orifice 180 may face a first plane at a first height, a second orifice 182 may face the first plane and may be at a second height and a third orifice 184 may face opposite the first plane and may be at a third height where all the heights may be different. On the inner ported cylinder, the first cylinder port 502 may face the first plane and may be at the first height, the second cylinder port 504 may face the first plane and be at the second height, the third cylinder port 506 may face opposite the first plane and be at the second height and the fourth cylinder port 508 may face opposite the first plane and may be at the third height. As a result, if the first orifice 180 and first cylinder port 502 are aligned, the second orifice 182 and the second cylinder port 504 may be aligned allowing flow through the first orifice 180 and the second orifice 182. Such an arrangement is illustrated in FIGS. 6 and 7.

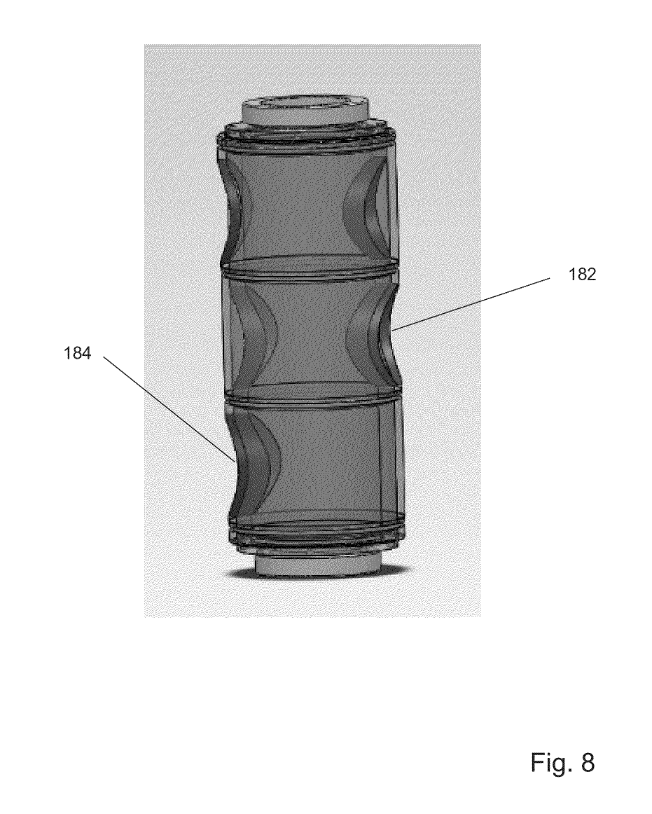

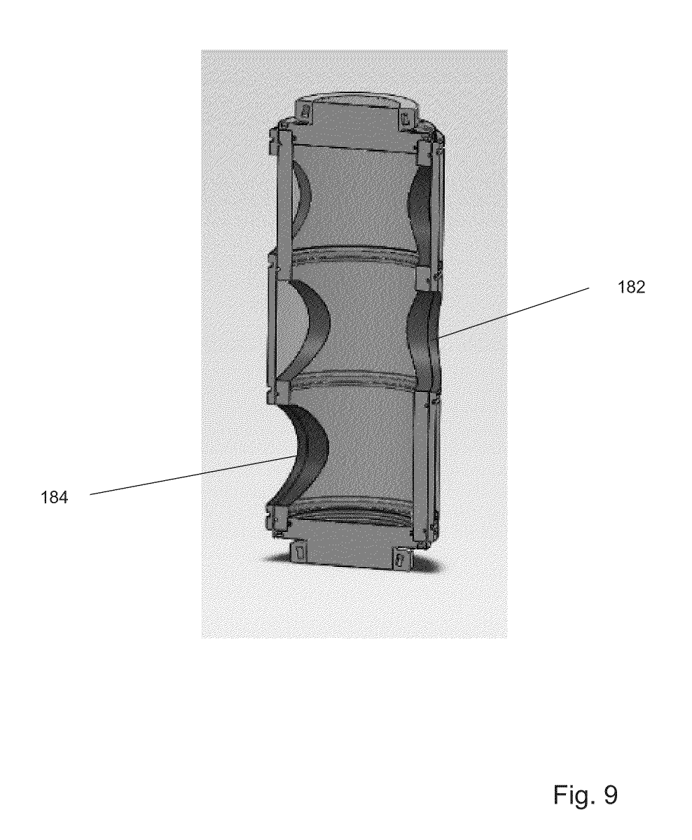

Similarly, if the third orifice 184 and the third cylinder port 506 are aligned, the second orifice 182 may be aligned with the second cylinder port 504 allowing flow out the second orifice 504. A possible embodiment of such an arrangement is illustrated in FIGS. 8 and 9.

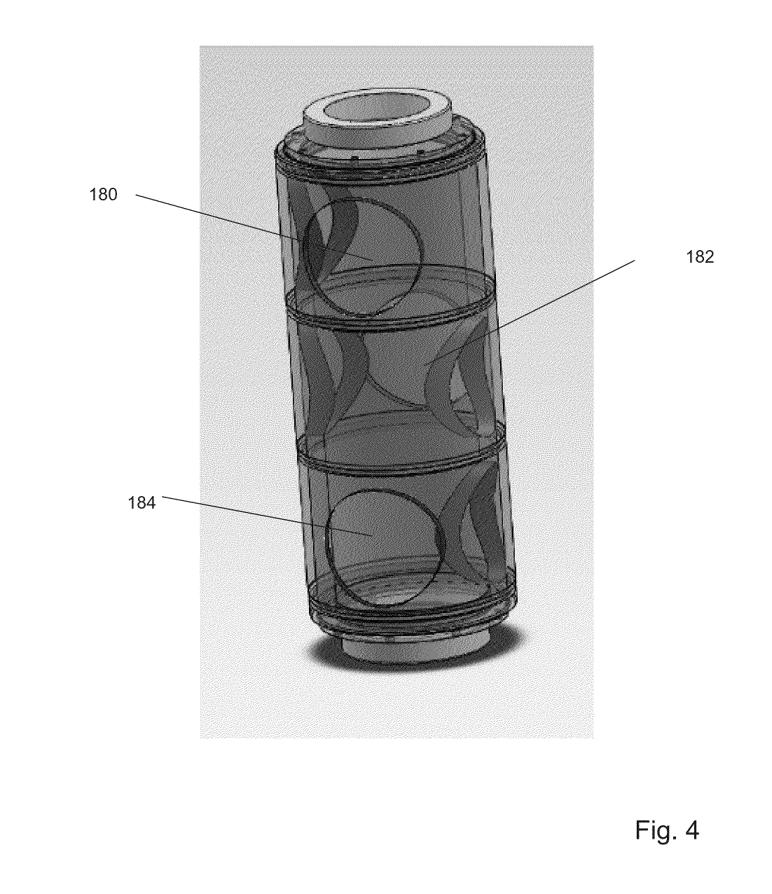

Further, if the first orifice 180 and first cylinder port 502 are not aligned, the first orifice 180 may be closed. Similarly, if the second orifice 182 and second cylinder port 504 are not aligned, the second orifice 182 may be closed. Finally, if the third orifice 184 and third cylinder port 506 are not aligned, the third orifice 184 may be closed. An example of the ports being closed is in FIGS. 4 and 5. Of course, the ports 502, 504, 506, 508 and orifices 180, 182, 184 could be arranged in a different manner that would allow different actions to open or close different orifices.

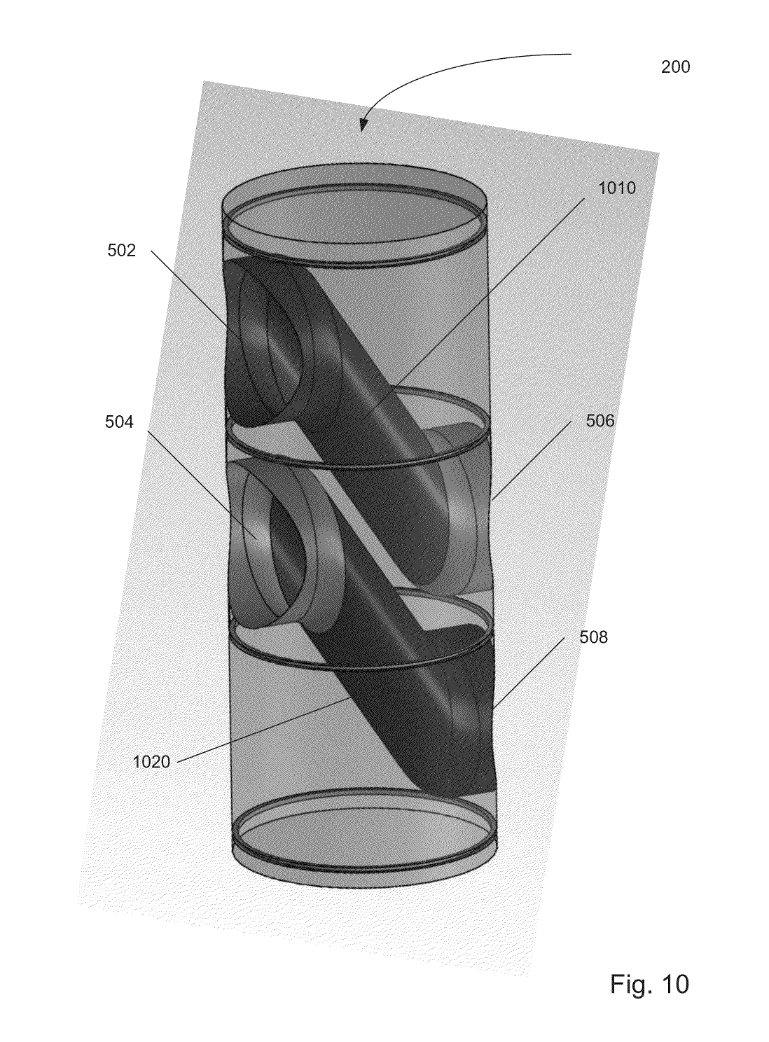

In another embodiment, the ported cylinder 200 may be solid and include additional tunnels or tubes 1010 1020 and surfaces to assist in material flow through the ports 502, 504, 506, 508. FIG. 10 illustrates one embodiment of a solid ported cylinder 200, such as a casting, with flow tunnels 1010 1020 that connect the ports 502, 504, 506, 508. As an example, a tube 1010 may connect port 502 to port 506 and a separate tube 1020 may connect port 504 to port 508. Of course, the tunnels 1010 1020 may be varied to connect different ports 502, 504, 506, 508 as desired. In some embodiments, the tunnels 1010 1020 may be the same size and in other embodiments, the tunnels 1010 1020 may have different sizes to better control the rate of flow through the ports. In addition, the surface of the tunnels 1010 1020 may be modified to better assist flow in a desired manner. As a result of being a solid piece, the ported cylinder 200 may have more strength, which may result in improved durability. In addition, the tunnels 1010 1020 may be designed and created in a manner to better control the rate of flow through the valve 100.

The ported cylinder 200 may also include a spindle 290 that corresponds to the first bearing and second bearing and may be in communication with the turning apparatus 270 adapted to turn the inner cylinder. The spindle 290 may be hollow allowing pressure, liquid or gas to be introduced into the valve 100. In other embodiments, the material to flow may be introduced through one of the orifices 180, 182, 184.

The outer surface of the inner cylinder comprises a ceramic coating. Similar to the coating on the outer tube 110, the coating may be a rod-form ceramic coating. In some embodiments, the coating may be molten, flamed-sprayed ceramic resulting in high particle-to-particle cohesive bonding. The rod-form process may deliver ceramic to the substrate with high kinetic energy and thermal mass for higher particle-to-particle cohesive bonding. In addition, heat transfer may be 50% lower than with other application methods which may avoid warp-age or distortion due to heat. In other embodiments, the coating may be a powder based coating.

### Single Level

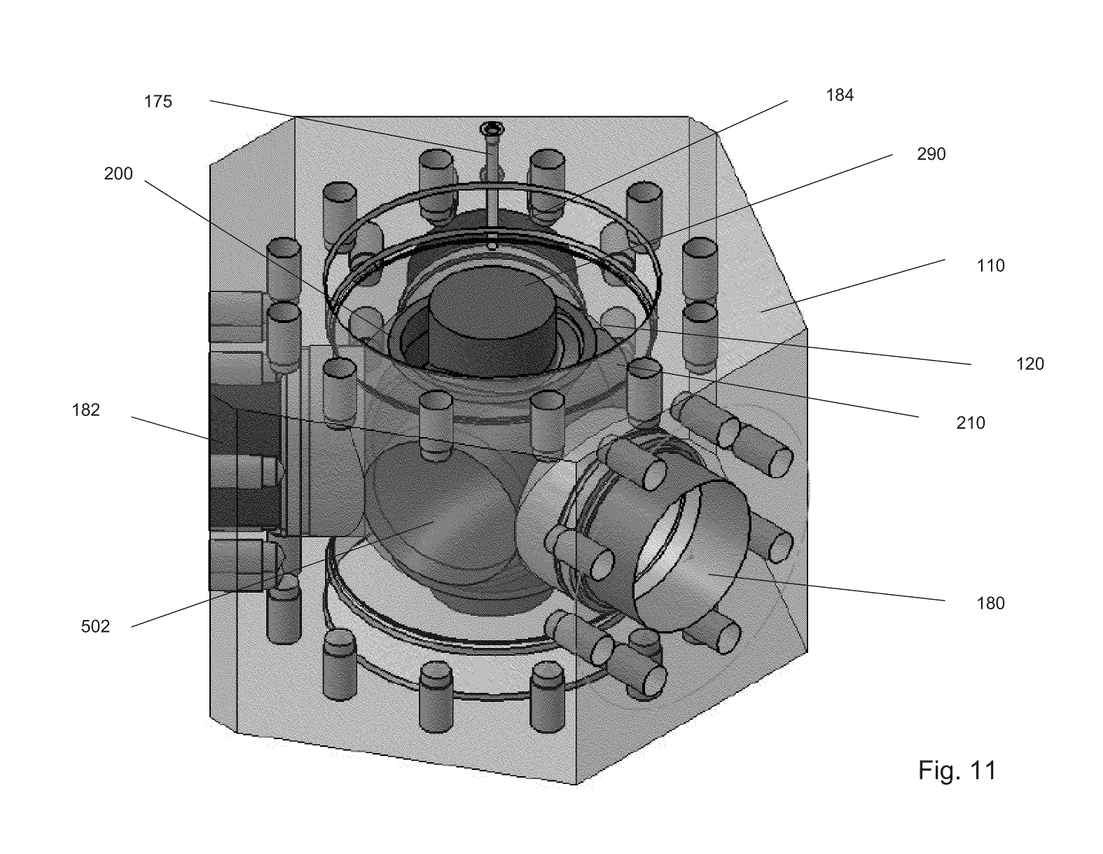

FIG. 11 may illustrate another embodiment of the rotary ceramic tube valve 100. As mentioned previously, other shapes of the outer body 110 may be accommodated so long as the inner ported rotor 200 has a complementary shape. In FIGS. 11-20, the outer body 110 is illustrated as being generally a pentagram or having a hexagonal shape and the inner ported cylinder 200 is illustrated as being round. Of course, other shapes and forms are possible and are contemplated. Orifices 180, 182, 184 may be present on the outer body 110 at various interval, such as at 120, 240 and 360 degrees. Thus, the first orifice 180 faces a first plane, the second orifices 182 faces a second plane and the third orifices 184 faces a third plane. The shape of the outer body 110 may allow the valve 100 to be placed in additional environments while continuing to provide great strength and durability while under extreme pressure.

The outer body 110 may have a complementary shape to the round inner rotor 200. Similarly, the inner surface 120 of the outer body 110 and the outer surface 210 of the inner rotor 200 may be coated with a ceramic surface. In this way, the inner ported rotor 200 may rotate inside the outer body 110 even while under great pressure. As will be discussed further, there also may be pressure communicating channels 175 that take pressure from the ports 180, 182, 184 and communicate the pressure to spherical pressure balancing seals 160 in the opposite side of the ports 180, 182, 184.

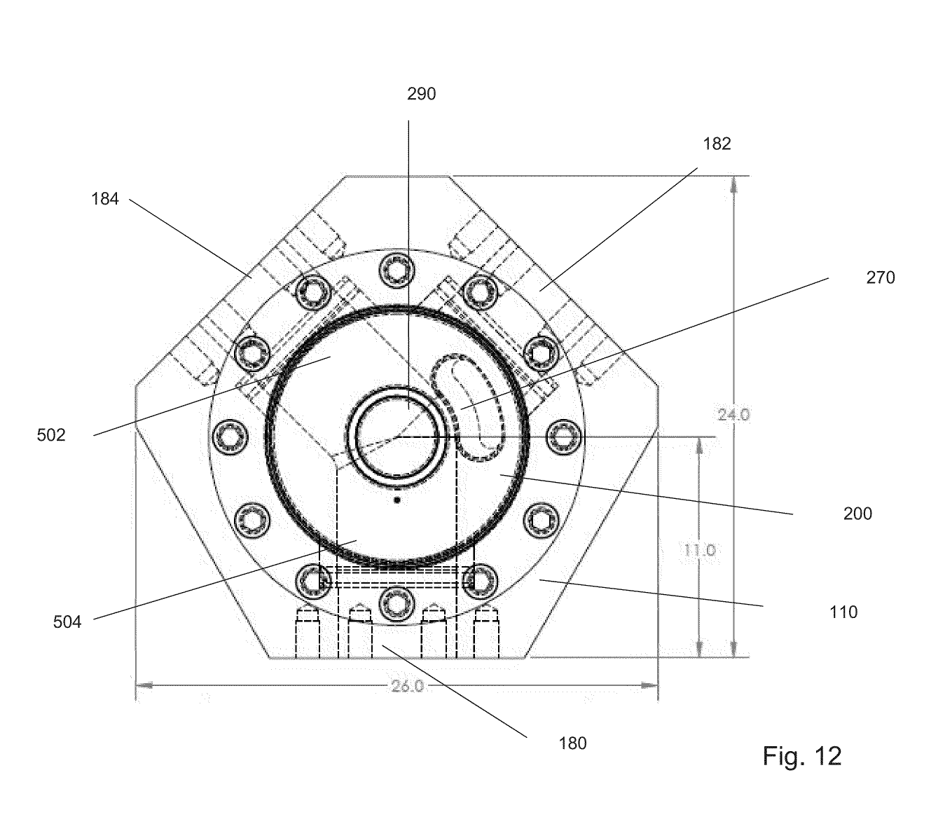

FIG. 12 may illustrate that the outer body 110 may have three orifices 180, 182, 184 while the inner ported rotor 200 may have two inner ports 502 and 504. Depending on the orientation of the inner ported rotor 200 inside the outer body 110, different orifices 180, 182, 184 may be in communication with each other or may not be in communication with each other as the inner ported rotor 200 is rotated.

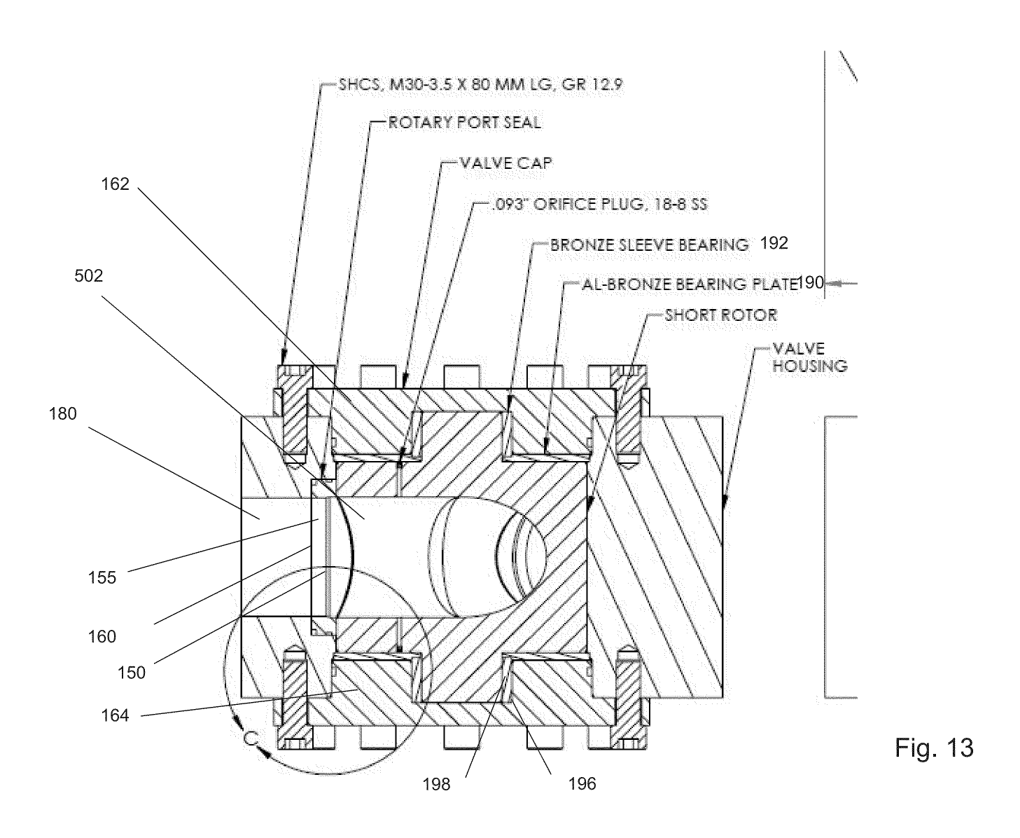

FIG. 13 may illustrate one embodiment of the construction of the outer body 110. The body may have a top 162 and a bottom 164 that are bolted or otherwise fastened to the body of the outer body 110. In this way, the inner ported rotor 200 may be placed inside the outer body 110. In addition, the seals 160 may be placed in the seal seat 150 with a seal retainer 155 holding the seal 160 in place. The spindle 290 may be held in place using a first bearing 192 which is held in a bearing seat 190 and a second bearing 198 which is held in a second bearing seat 196. The bearings 192 198 may assist in controlling the spindle 290 which may control the inner ported cylinder 200 while allowing the spindle 290 to turn with adequate effort.

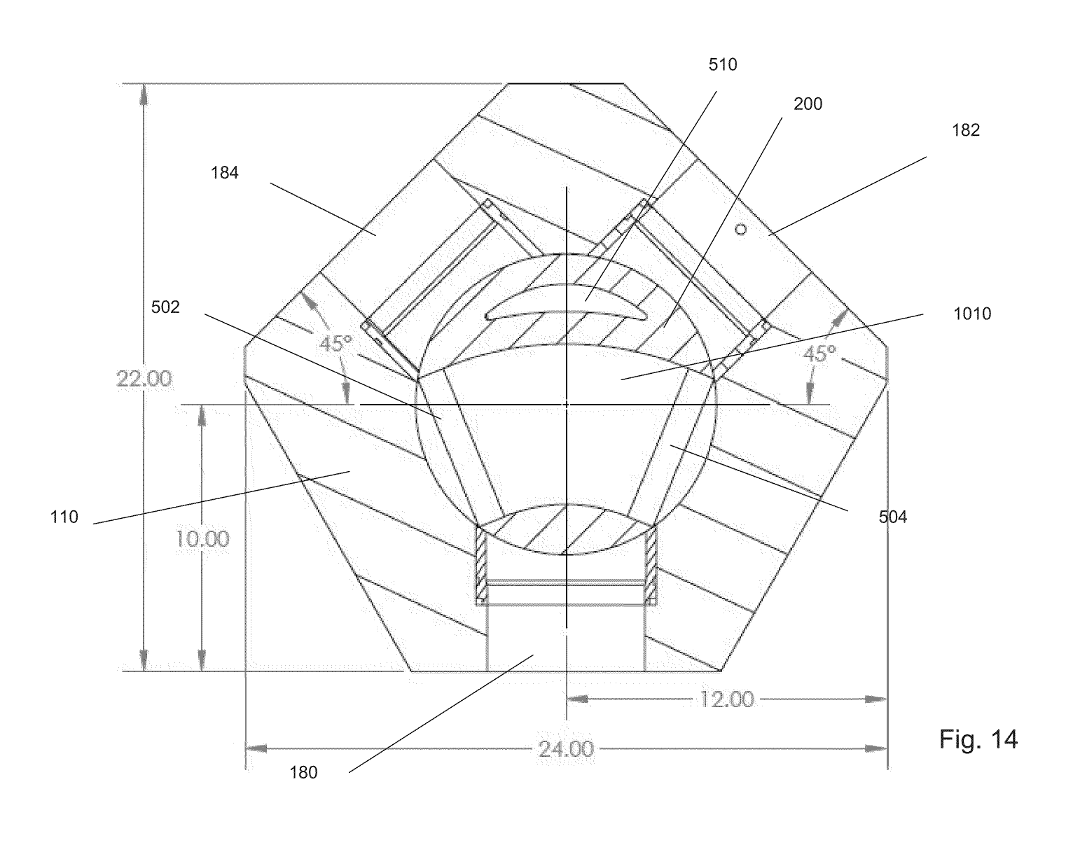

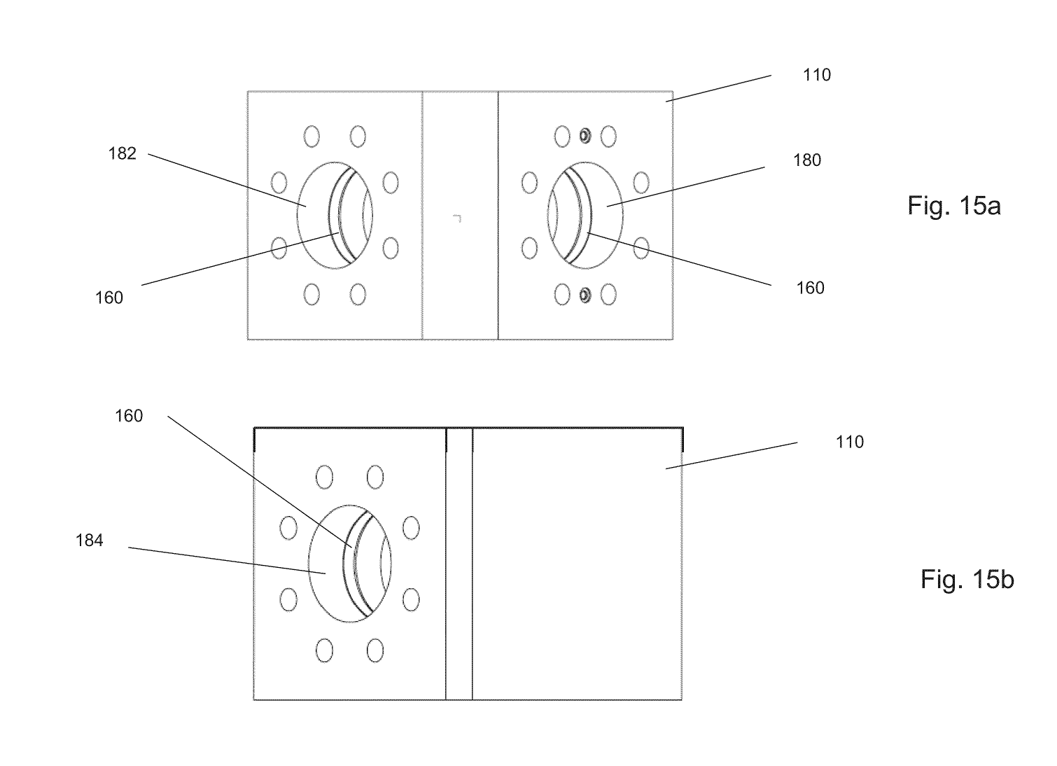

FIG. 14 may be an overhead view of the inner ported rotor 200 inside the outer body 110. In addition, a mass saving opening 510 may be illustrated. By removing a portion of the inner ported rotor 200, the mass of the rotating inner ported rotor 200 may be reduced, thereby making turning and adjusting the flow through the valve 100 easier. While the mass may appear trivial, the pressure on the valve 100 and size of the valve 100 may result in even small savings in mass have a large effect on performance of the valve 100. Further, the orientation of the inner ported rotor 200 inside the outer body 110 may indicate that the valve may be closed, allowing no flow through the tube 1010 to the orifices 180 of the outer body 110. FIG. 15 may be another illustration of the outer body 110. The various orifices 180, 182, 184 may be seen with the seals 160 also being in view.

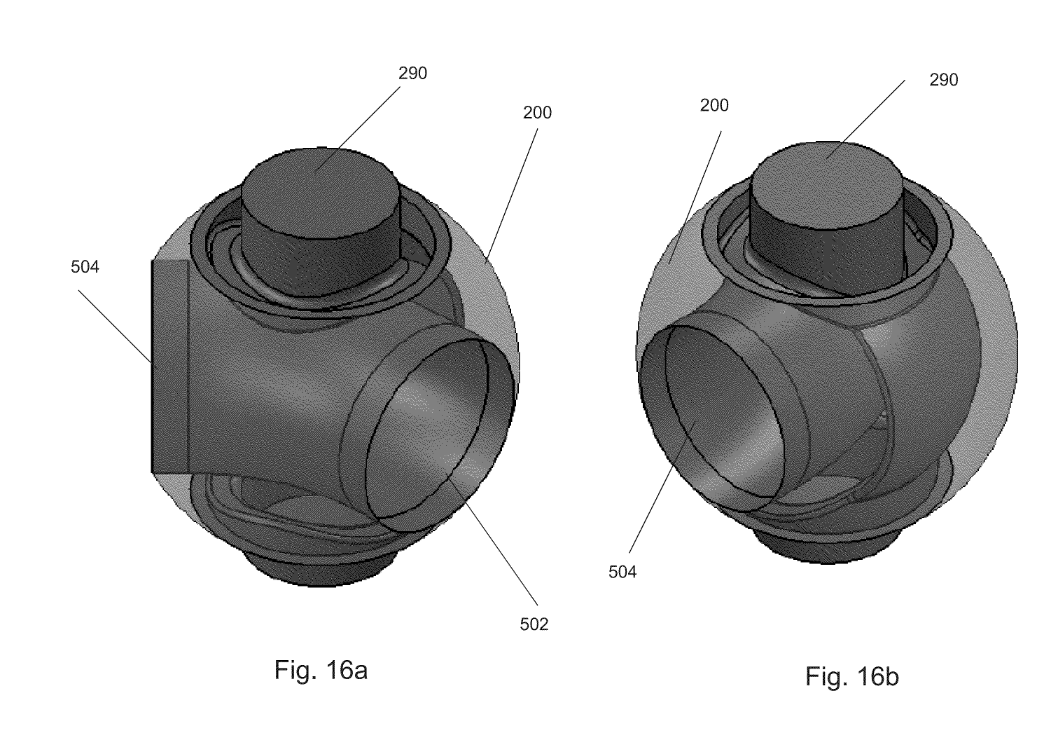

FIGS. 16a and 16b may be illustrations of the inner ported rotor 200. In this example, the inner ported rotor 200 may be round or oval, matching the interior space of the outer body 110. The inner rotor 502 and 504 may be sized and located in a manner to match the orifices 180, 182, 184 in the outer body 110 when the inner ported rotor 200 is rotated in various orientations. The inner ported rotor 200 may also have a spindle 290 that assists in maintaining the desired orientation of the inner ported rotor 200 and may make rotating the inner ported rotor 200 easier.

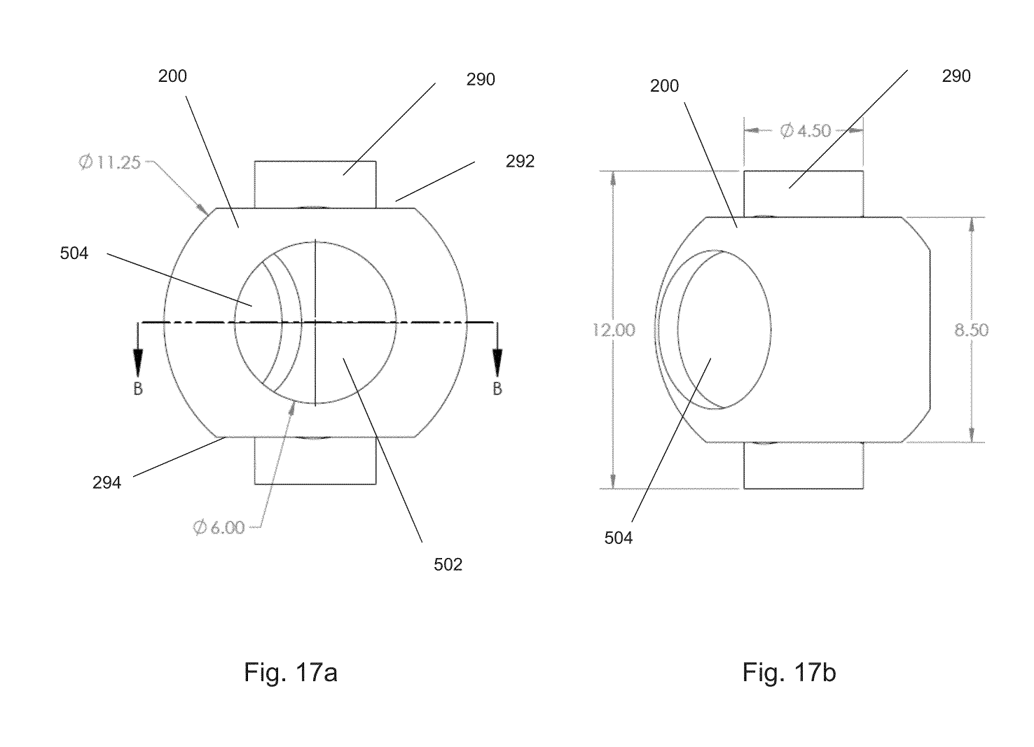

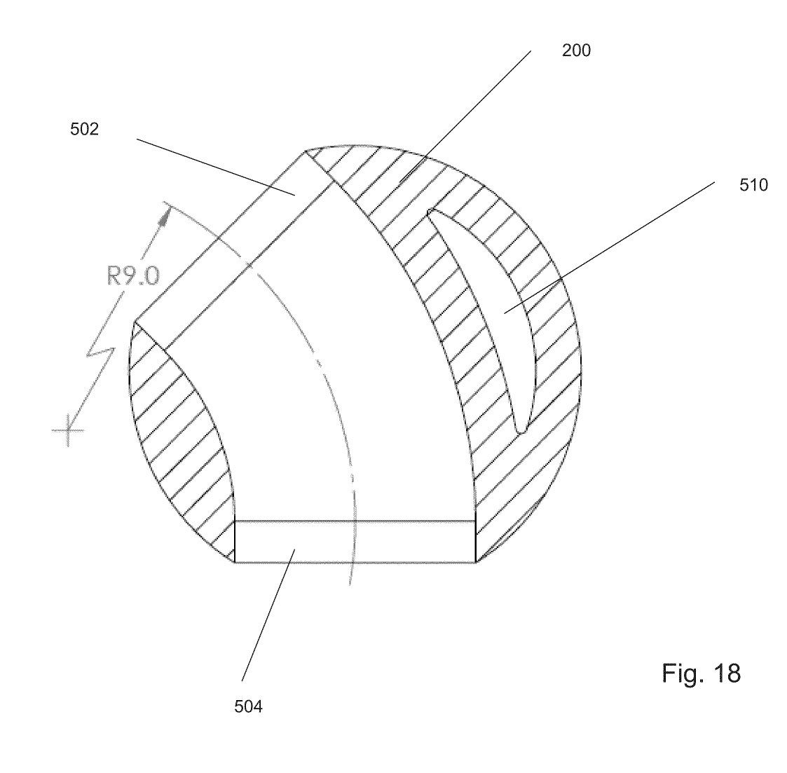

FIGS. 17a and 17b may illustrate the profile of the inner ported rotor 200 as being round or oval with relative flat top 292 and bottom portions 294 surrounding the spindle 290 to match the related inner regions of the outer body 110. The round or oval shape may be useful in withstanding pressure while being relatively easy to turn even under great pressure. FIG. 18 may be an overhead view of the inner ported rotor 200 that may illustrate the orientation of the inner ports 502 and 504 along with the open region 510 which reduces mass while not affecting the strength of the ported rotor 200 in a negative or unacceptable manner.

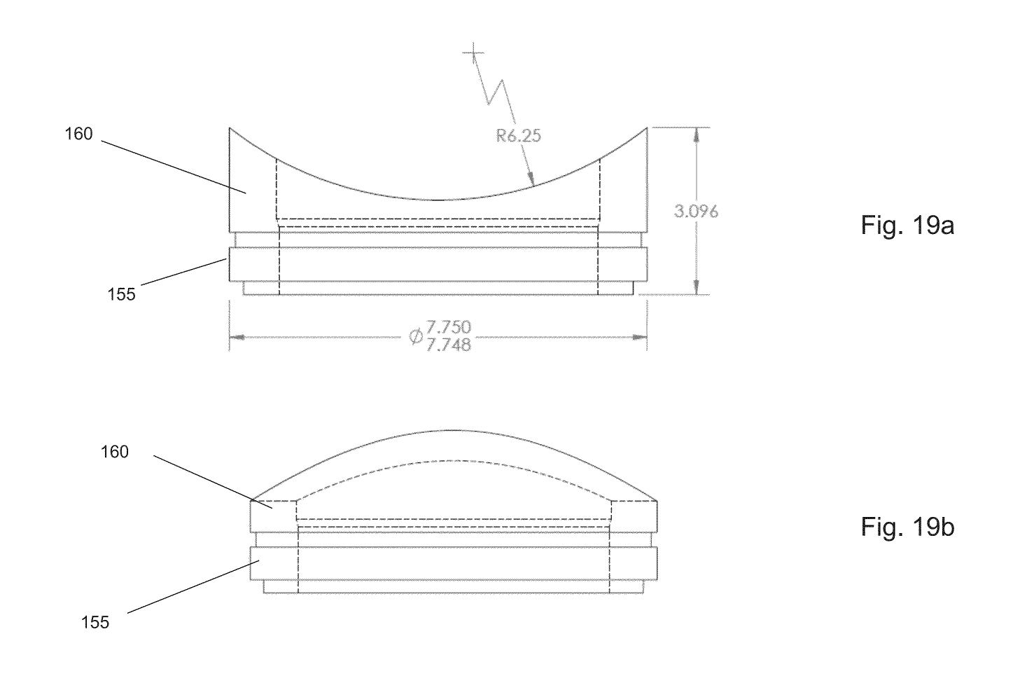

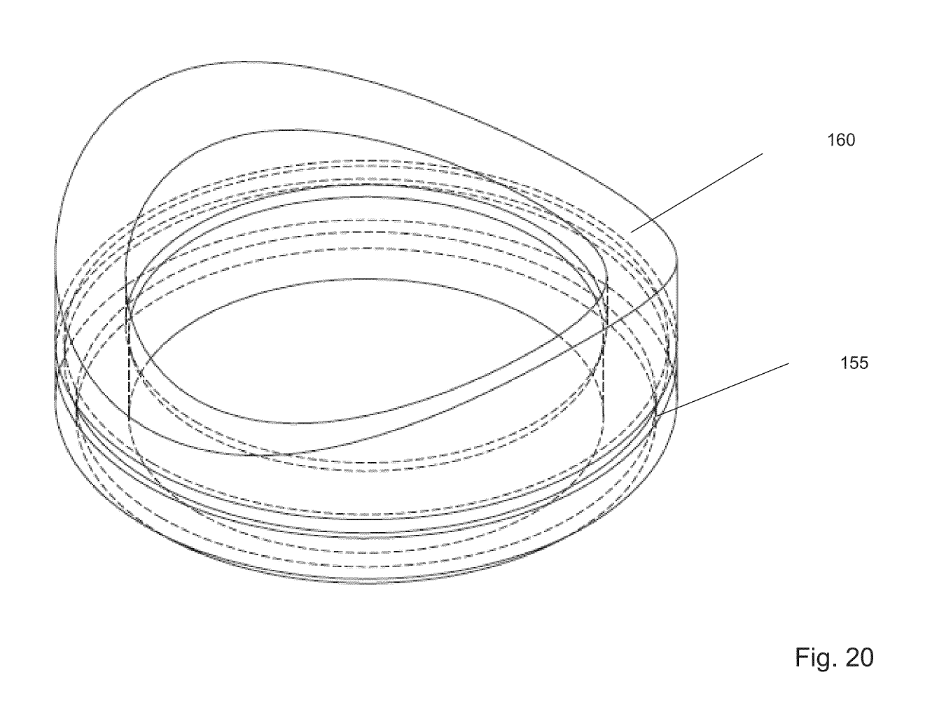

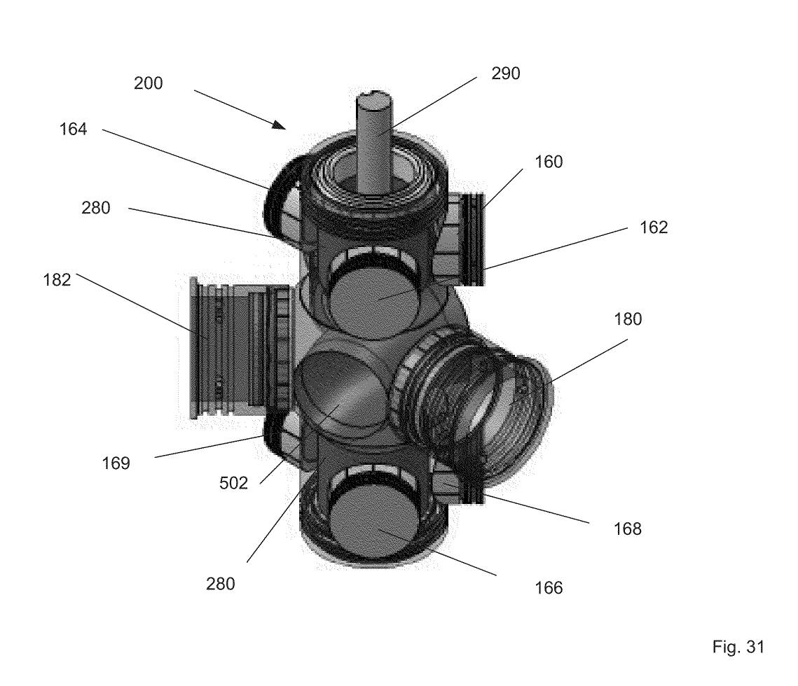

FIGS. 19a, 19b and 20 may illustrate the cylindrical pressure balance seals 160. Referring briefly to FIG. 31, the cylindrical pressure balance seals 160 may exert pressure to help control and provide stability to the rotor 200. The cylindrical pressure balance seals 160 may include seal retaining rings 155 which may be shaped to be held firmly by the seal seat 150. The cylindrical pressure balance seals 160 may receive the balancing pressure in a variety of ways, including from an external pressure source or from the ports on the opposite side of the cylindrical pressure balance seals as will be further explained.

As the inner ported cylinder 200 in this embodiment has an oval or rounded shape, the seal 160 may be shaped to match or be complementary to the shape of the inner ported cylinder 200. Logically, the seal 160 may be held in place using a seal retainer 155 which may be shaped to be held firmly by the seal seat 150. As the top 162 and bottom 164 of the valve 100 may be removed, the seals 160 may be removed and replaced as needed without having to replace the entire valve 100.

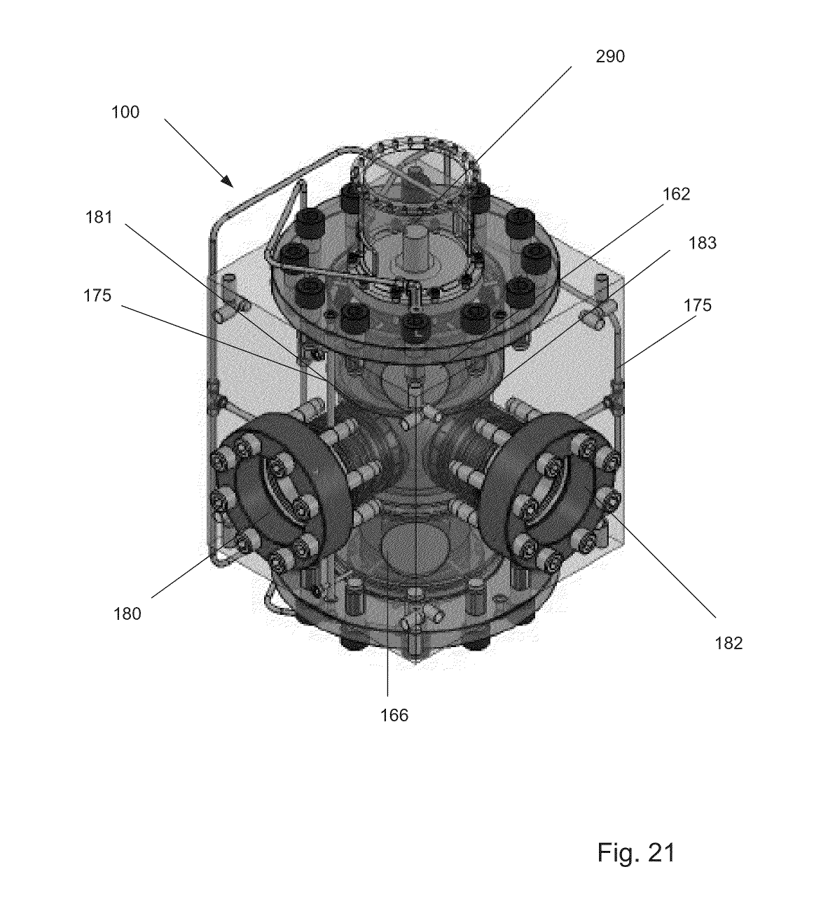

FIG. 21 may be an illustration of another embodiment of the valve 100 that cylindrical pressure balance seals 160. As mentioned previously, the shape of the outside of the valve 100 may be a plurality of shapes. In FIG. 21, the shape is more rectangular. The valve 100 may still have three ports 180 182 184 and in some embodiments, a first port 180 is on a first side or plane 2100, a second port 182 is on a second plane 2110 and a third port 184 is on a third plane 2120.

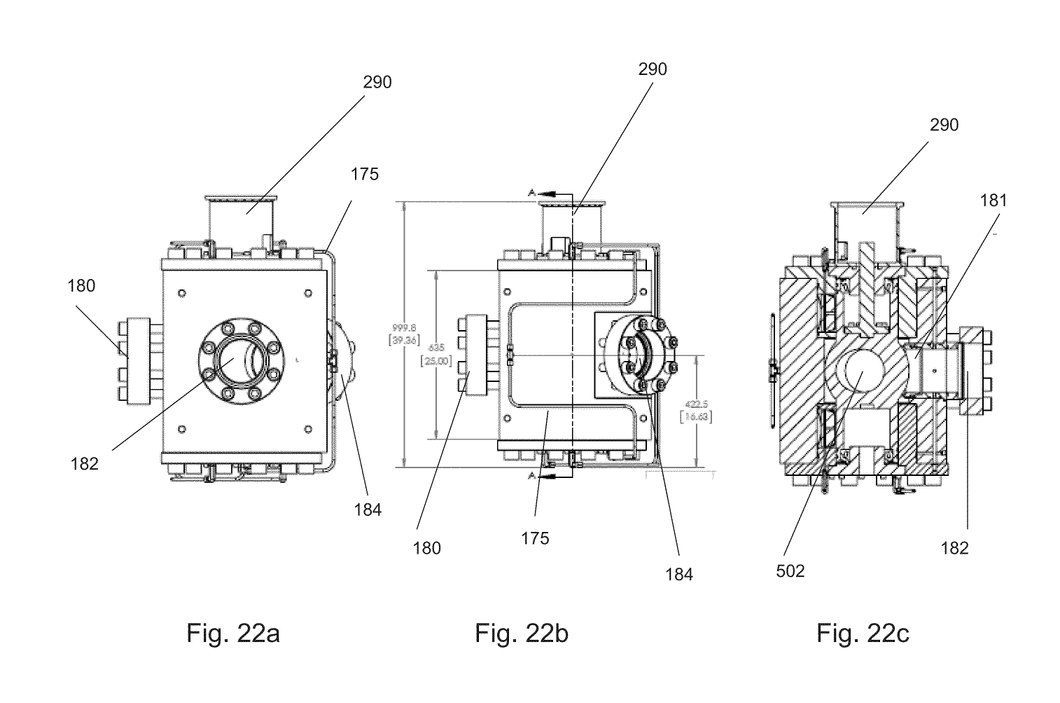

The inner section of the body 120 may also have a variety of shapes that may be complementary to the rotor 200. In some embodiments, the inner rotor 200 may be cylindrical such as in FIG. 1. In other embodiments as illustrated in FIG. 22c, the shape of the inner rotor 200 may be primarily cylindrical with a rounded portion being used to communicate with the orifices 180 182 184 of the outer body 110 through spherical port seals 181, 183, 185 to control pressure through the valve 100.

As the pressure on the valve 100 and rotor 200 may be extremely high and the turning requirement may be demanding, care may be taken to ensure long safe and safe operating of the valve 100. As a result, bearings 192 198 may be used that can withstand extreme pressure but still allow the rotor 200 to turn while under extreme pressure which may make movement more difficult.

In some embodiments, advanced cylindrical pressure balancing seals 160 may be used to withstand and balance the pressure. For example, in FIGS. 20-31, pressure may be balanced from the orifices 180 182 184 to the opposing cylindrical pressure balancing seals 160. Pressure from port 180 will be communicated through tubing 175 to balancing seals 164 and 169 and balance the pressure on the rotor regardless of its' position. Subsequently, port 182 will work in conjunction with balancing seals 160 and 168 as will port 184 work with balancing seals 162 and 166.

The pressure communication tubing 175 may be external of the valve shell 110 as illustrated in FIG. 21 or the pressure may communicate through openings or tubes 175 inside the valve shell 110 itself (not shown). The pressure may flow (FIG. 31) from an opening in a port 180 through the pressure channels 175 to the cylindrical pressure balancing seals on the opposite side 164 and 169.

The cylindrical pressure balancing seals 160 162 164 166 168 169 may be filled with hydraulic fluid. The cylindrical pressure balancing seals 160 162 164 166 168 169 may be in communication with trunnions 280 which may be fixed on the spindle 290. The spindle 290 may turn on a film of hydraulic fluid emitted from the cylindrical pressure balancing seals 160 162 164 166 168 169. As pressure flows to a port 180 on the valve 100, the pressure on the cylindrical pressure balancing seal 160 may be communicated through the pressure balancing tubes 175 to the first cylindrical pressure balancing seal 169 and the second cylindrical pressure balancing seal 164 on the side of the valve 100 opposite the port with pressure at hand 180. By supplying the pressure to the cylindrical pressure balancing seals 169 164, the spindle 290 will be able to turn in an easier manner than if the pressure was not supplied. In addition, force on the bearings 192 198 will be reduced which may result in longer bearing 192 198 life and easier turning of the trunnion 280 as the pressure on the bearings 192 198 will be less.

FIGS. 22a, FIG. 22b and FIG. 22c may illustrate the valve of FIG. 21 from a variety of perspectives. In FIG. 22a, the three orifices 180 182 184 may be seen and the spindle 290 may be used to rotate the inner rotor 200. The pressure balancing tubing 175 may also been seen communicating from a port 184 to the first cylindrical pressure balancing seal 162 and second cylindrical pressure balancing seal 166 to provide force to balance the enormous forces that may be on the inner rotor 200.

FIG. 22b is another view of the valve 100 of FIG. 21. In this view, the pressure balancing tubing 175 is even more visible. As may be seen, the pressure balancing tubing 175 may be a passive system such as a loop system. The fluid in the pressure balancing tubing 175 may be under pressure and the additional pressure when the spindle 290 and inner rotor 200 are rotated may be transferred from the seal port 180 to the first cylindrical pressure balancing seal 169 and second cylindrical pressure balancing seal 164. This additional pressure on the first cylindrical pressure balancing seal 169 and second cylindrical pressure balancing seal 164 may reduce the pressure on the bearings 192 198, may require less force to rotate the inner rotor 200 which all may result in a more reliable, long lasting, high performance valve 100.

FIG. 22c may be a cutaway illustration of the valve 100. The view may illustrate that the inner rotor 200 may have a section near the inner ports 502 504 506 may be round while the trunnion 280 may be cylindrical. The round shape near the inner ports 502 504 506 may provide additional strength when the ports 502 504 506 are subjected to extreme pressure.

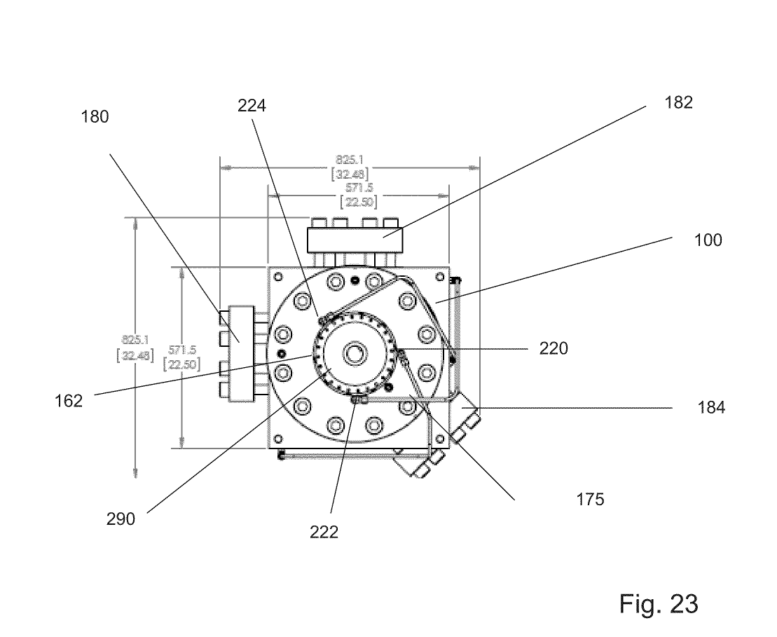

FIG. 23 may be an overhead view of the square shaped valve 100 of FIG. 21. As can be seen, the pressure balancing tubing 175 travels from an orifice 180 182 184 to the side of the cylindrical pressure balancing seal 162 164 opposite the orifice 180 182 184. More specifically, when the cylindrical pressure balancing seal 160 for the orifice 180 is under pressure, it will communicate fluid to the first cylindrical pressure balancing seal 164 and 169 on a side opposite 220 the orifice 180. Similarly, when the cylindrical pressure balancing seals 160 for the orifice 182 is under pressure, it will communicate fluid to the first cylindrical pressure balancing seal 160 and 168 on a side opposite 222 the orifice 182. Finally, when the cylindrical pressure balancing seals 160 for the orifice 184 is under pressure, it will communicate fluid to the first cylindrical pressure balancing seal 162 and 166 on a side opposite 224 the orifice 180. As a result, the pressure from the cylindrical pressure balancing seals 160 for the orifices 180 182 184 in the outer body 110 may be transferred to the first cylindrical pressure balancing seal 162 and second cylindrical pressure balancing seal 166 on sides opposite the orifices in a passive manner. As the pressure increases, the fluid pressure in the cylindrical pressure balancing seals 160 162 164 may increase and as pressure decreases, the fluid pressure in the cylindrical pressure balancing seals 160 162 164 may decrease.

In yet another embodiment, the fluid may be transferred using a non-passive system such as a powered system that uses a controller (not shown). The controller may take in input data about pressure on the spindle 290, valve insert 200, the various orifices 180 182 184, the inner ports 502 504 506 and determine how to offset the pressure by apply pressure in an opposite manner of the sensed pressure. Of course, the controller may be in communication with a pump (not shown) which may provide the desired pressure or the controller may control valves which regulate the pressure as desired. Other arrangements are possible and are contemplated.

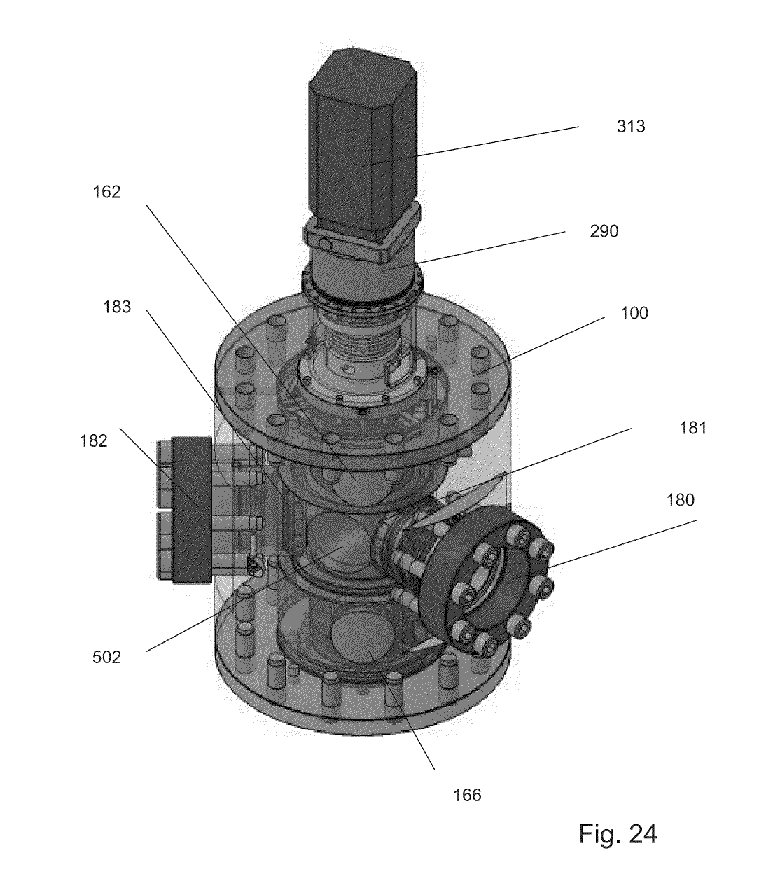

FIG. 24 may illustrate yet another embodiment of the valve 100. The valve 100 may have a more cylindrical shape which will has little or no effect of the performance of the valve 100. The valve 100 still may have three or more (or less) orifices 180 182 184 and the direction of the orifices 180 182 184 may vary. An inner rotor 200 may be of a shape to match the inner area of the outer body 110. As has been mentioned previously, the inner surface 120 of the outer body 110 and the outer surface 210 of the rotor 200 may be ceramic coated which may assist in the rotor 200 being able to turn while withstanding enormous pressure. In addition, while not shown in this embodiment, the pressure seals 162 164 and pressure balancing tubing 175 from FIG. 23 may be used on any of the embodiments, including the embodiment in FIG. 24. Further, a transmission 313 may be used to assist in control the torque from a turning motor (not shown) as applied to the spindle 290.

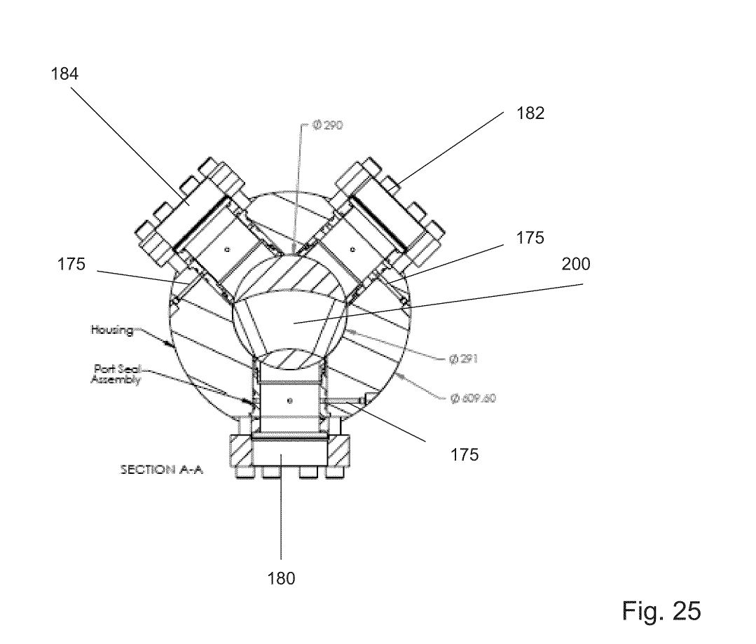

FIG. 25 may be an overhead cut-away view of a valve 100 like the valve from FIG. 24. As can be seen, the outer housing 110 is round and has three orifices 180 182 184. A ported rotor 200 may also be seen. The cylindrical pressure balancing seals 160-169 may be in communication with orifices 180, 182 and 184 and as example may direct the flow of the fluid from the spherical seal 181 to the first cylindrical pressure balancing seal 169 and second seal 164 on side opposite the spherical seal 181 under pressure as illustrated in FIG. 24. As mentioned previously, the fluid may be transferred in any appropriate manner, such as through tubing or through dedicate channels in the body 100.

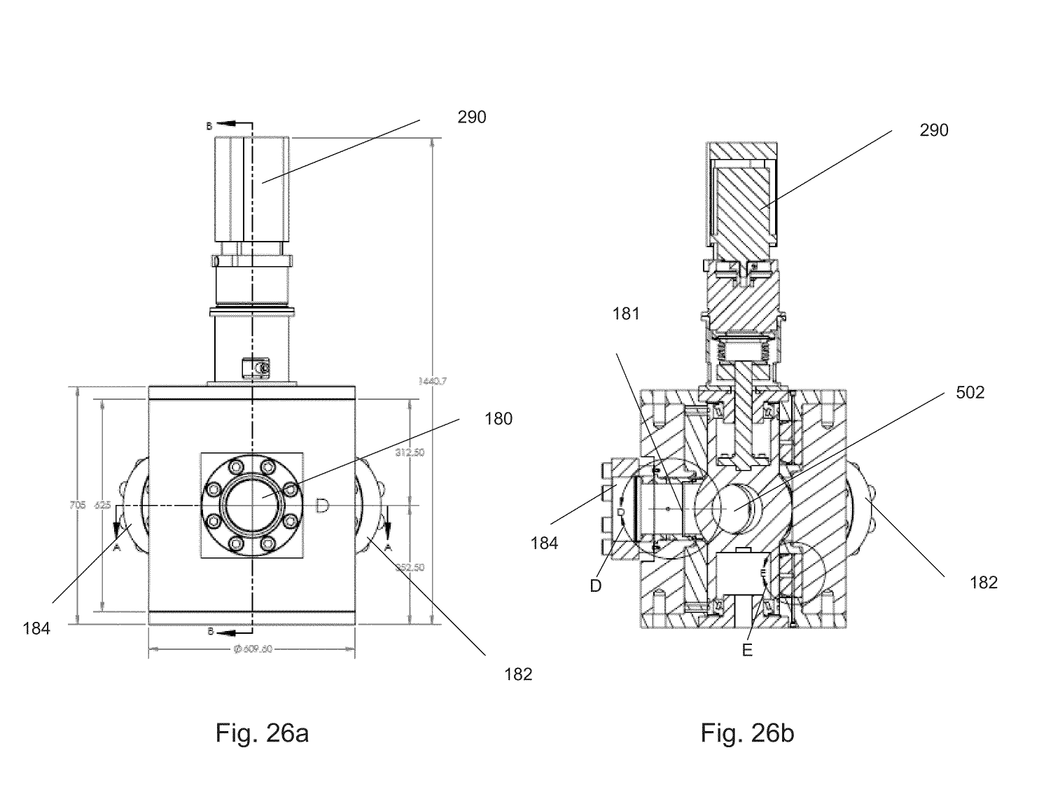

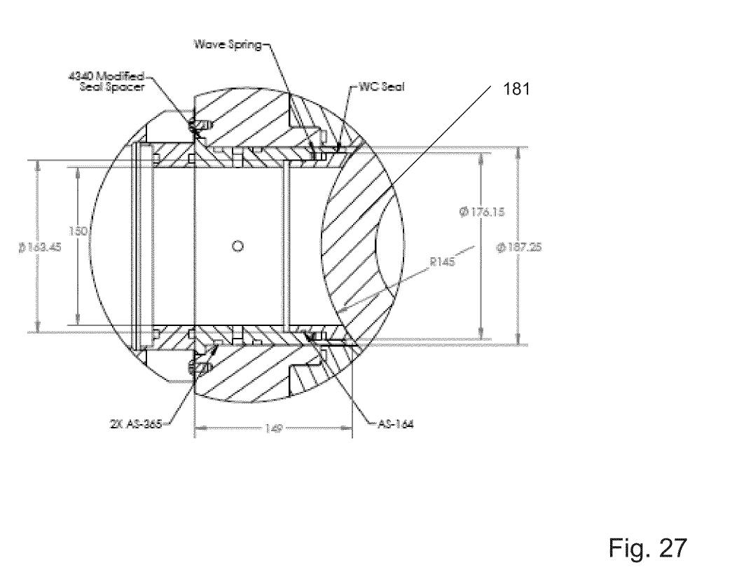

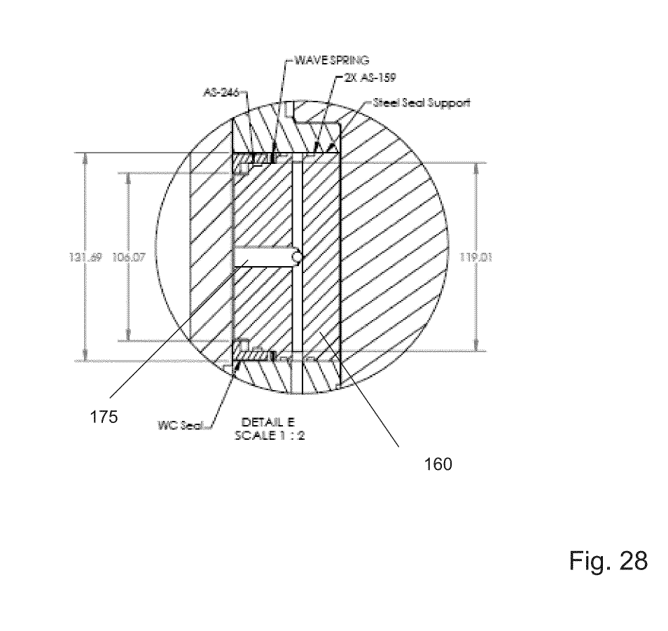

FIGS. 26a and 26b may be illustrations of a round embodiment of the valve 100. Detail of area D is in FIG. 27 and detail of circular area E is in FIG. 28. Referring to FIG. 27, the spherical seal 181 is illustrated in greater detail.

FIG. 28 may illustrate the cylindrical pressure balancing seals 160-169. Again, the cylindrical pressure balancing seals may have the ability to receive pressurized fluid which may enhance the sealing ability of the seal. In addition, when the cylindrical pressure balancing seal 164 is under pressure, the fluid may be forced out of the seals through pressure balancing tubing 175 to provide counter pressure as described in reference to FIG. 23. Again, the cylindrical pressure balancing seals may receive fluid which may assist the cylindrical pressure balancing seals in balancing the pressure on the spindle 191 and rotor 200. The cylindrical pressure balancing seals may communicate fluid through the pressure balancing tubing 175 to ensure ideal operation of the cylindrical pressure balancing seals and the valve 100.

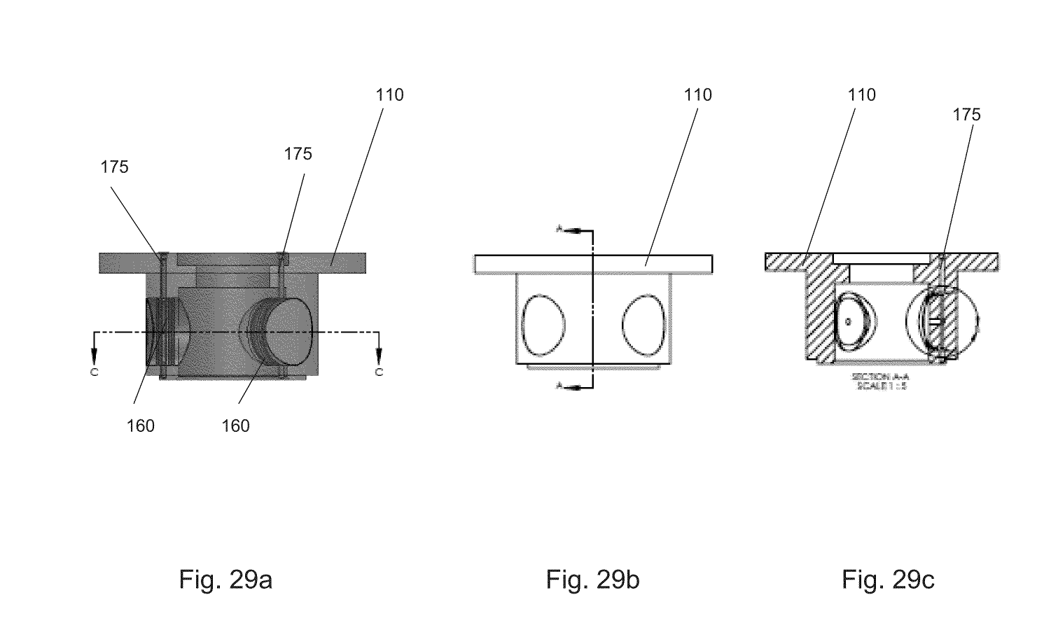

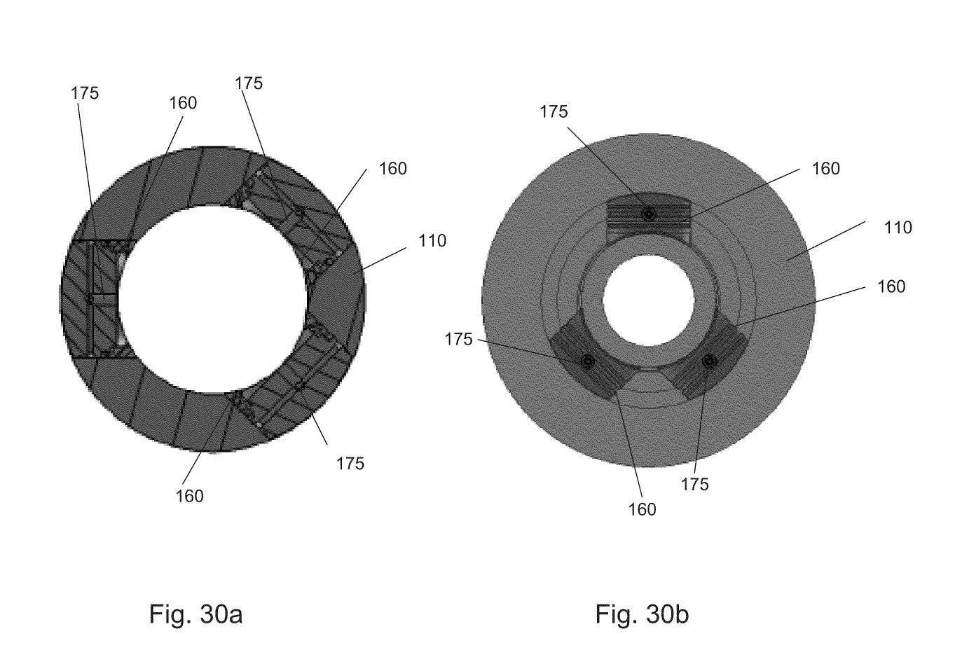

FIGS. 29a, 29b, 29c, 30a and 30b may be different views of the ported rotor 200 inside the body 110. In FIGS. 29a and 29c, the pressure balancing tubing 175 which may be in communication with the cylindrical pressure balancing seals 160 may be seen proceeding through the outside body 110. The inner rotor 200 may be more cylindrical and less rounded than in previous Figures. FIG. 29b may illustrate the outer body 110 alone. FIGS. 30a and 30b are additional views of the upper and lower valve caps 110 with pressure balancing seals installed from an overhead perspective. The pressure balancing tubing 175 may interface with the cylindrical pressure balancing seals 160 which may provide better sealing and improved control of the inner ported rotor 200.

FIG. 31 may illustrate the inner rotor 200 which may direct the pressure 200. As previously explained, the rotor 200 may have a plurality of ports 502 504 506 which interface with the orifices 180 182 184 through the spherical port seals 181 183 185. The trunnion 280 with force from the cylindrical pressure balancing seals 160-169 may add stability to the rotor 200. The spindle 290 may be used to turn the director 200 as required and provide additional strength. Of course, other shapes and designs are possible and are contemplated.

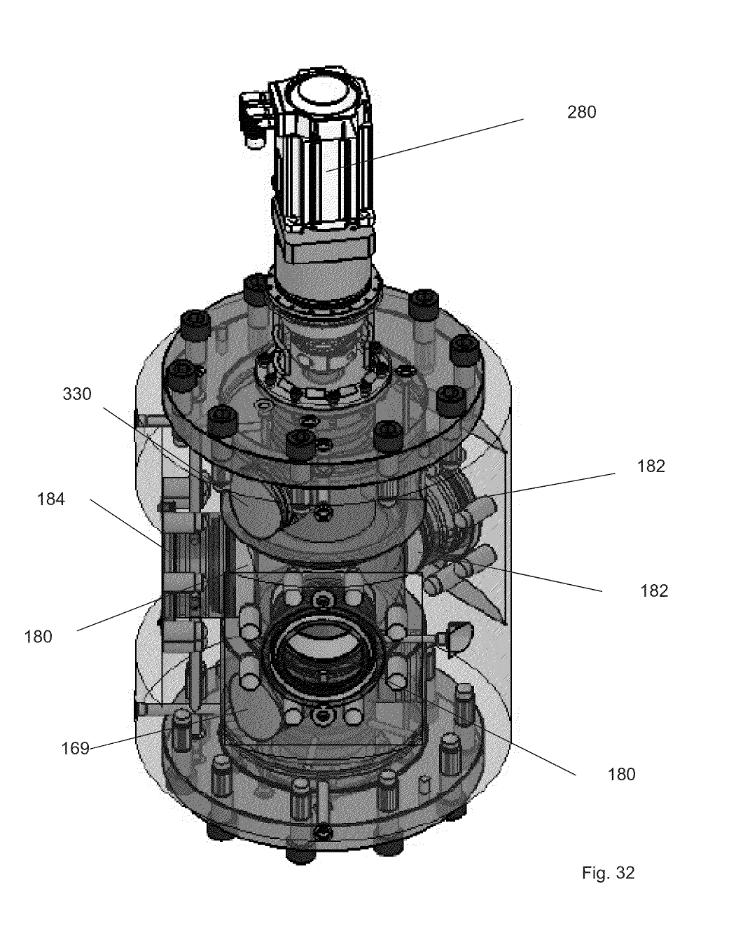

FIG. 32 may illustrate yet another embodiment of the valve 100. In this embodiment, the valve 100 body may be primarily round. In addition, cylindrical pressure balancing seals 160 may be used to balance the pressure on the valve 100.

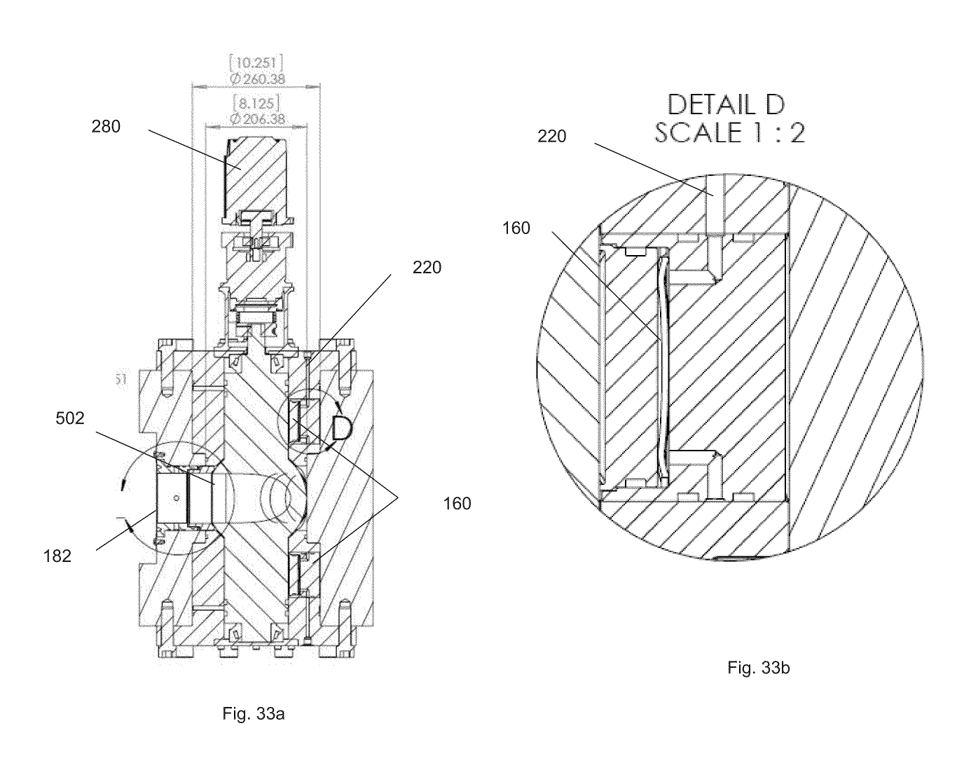

FIG. 33a may be a cutaway view of the valve 100 from FIG. 32 that illustrates the presence of the cylindrical pressure balancing seals 160. As described in FIG. 21, pressure may be communicated from one side of the valve 100 to the other side to equalize pressure on the spindle 290. In FIG. 33a, the cylindrical pressure balancing seals 160 may be seen in more detail. A tube may be in communication with an opposite side of the spindle 290 such that pressure on the spindle 290 and the rotor 200 (such as pressure from an open port 180) may be offset on the opposite side of the spindle 290. The cylindrical pressure balancing seals 160 may take on a variety of forms, such as a rectangular form, a bladder shape or any other shape that is appropriate to be in communication with the trunnion 280 and the valve 100 itself.

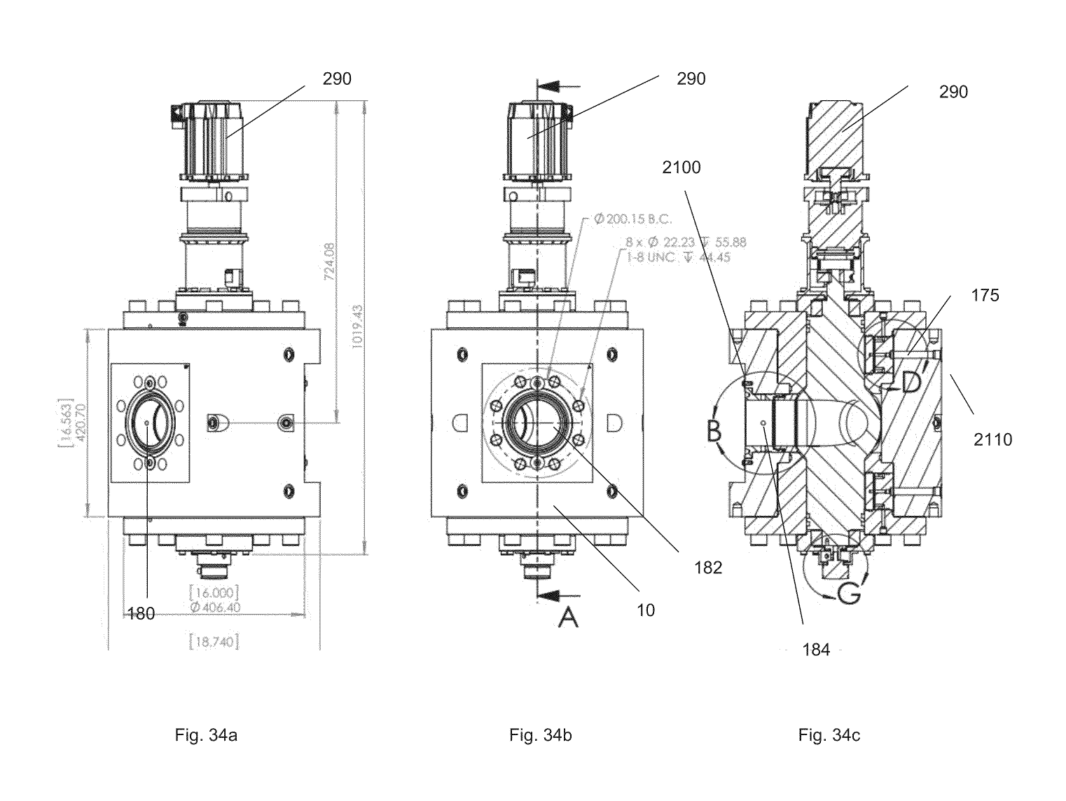

FIGS. 34a, 34b and 34c may be illustrations of yet another embodiment of the valve 100. The valve 100 may be somewhat smaller than previous embodiments. It may have pressure balancing tunnels or channels 175 that communicate pressure from a first side 2100 of the inner rotor 200 to a second side 2110 of the inner rotor 200 where the first side 2100 is opposite the second side 2110.

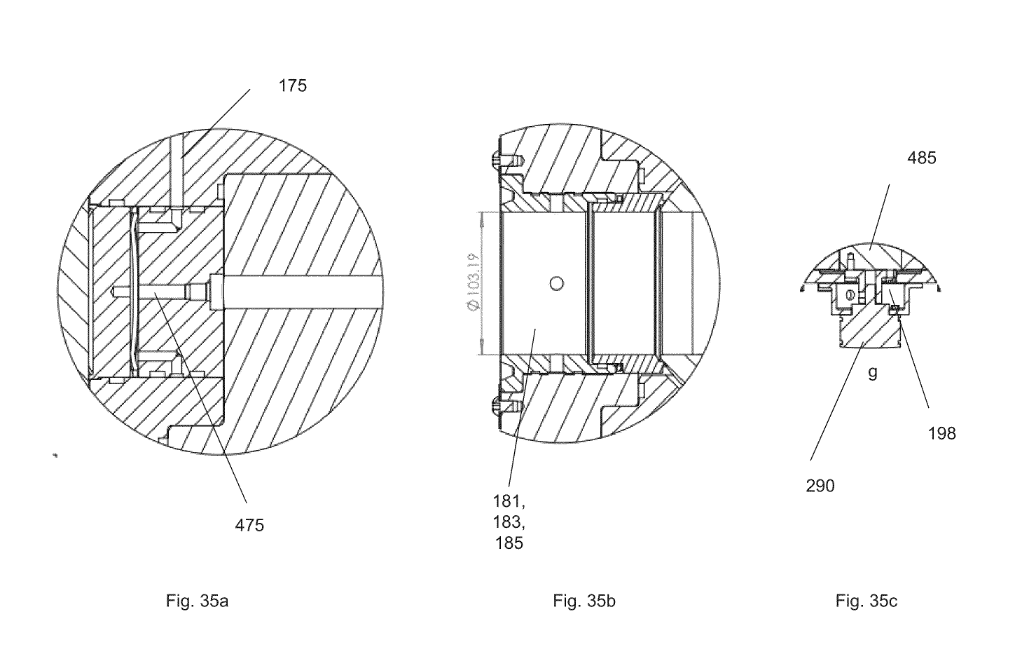

FIG. 35a may be a more detailed illustration of a cylindrical pressure balancing seal 160 from FIGS. 34a, 34b and 34c in communication with a pressure sharing vessel 175. FIG. 35a may be a more detailed illustration of a cylindrical pressure balancing seal 160 including the relief access 475 which may allow the cylindrical pressure balancing seal 160 to be pulled back such that the rotor 200 may be inserted into the housing 110. A screw may be inserted into the relief access 475 and may be used to pull back the cylindrical balancing seals for installation. FIG. 35b may be a more detailed illustration of the spherical port seals 181, 183, 185.

FIG. 35c may be a more detailed illustration of an encoder 485 on a spindle 290 in a bearing 198. The encoder 485 may be used to keep track of the position of the rotor 200. Using the encoder 485, the exact position of the rotor may be known which may allow better control of the rotor 200 and the pressure through the valve 100.

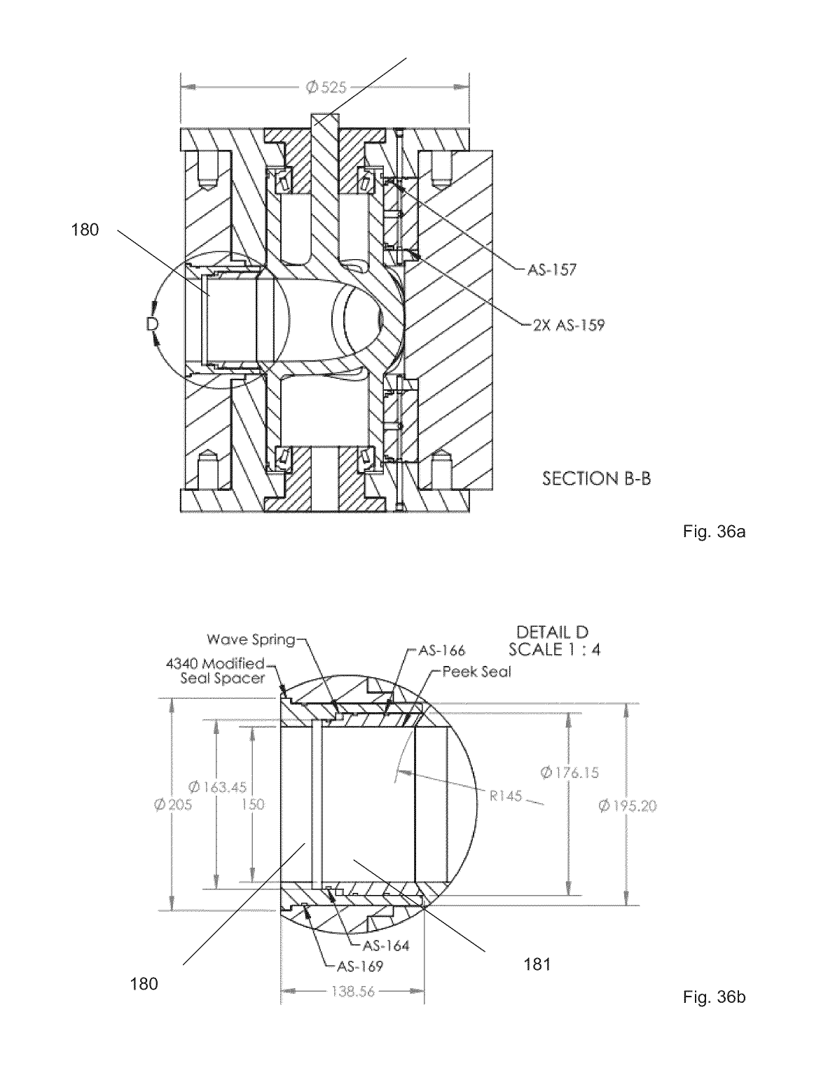

Similarly, FIG. 36a may be an illustration of an open port 180 in the valve 100 and FIG. 36b may be a more detailed view of the inner port 180 including the location of the spherical port seals 181 and wave spring.

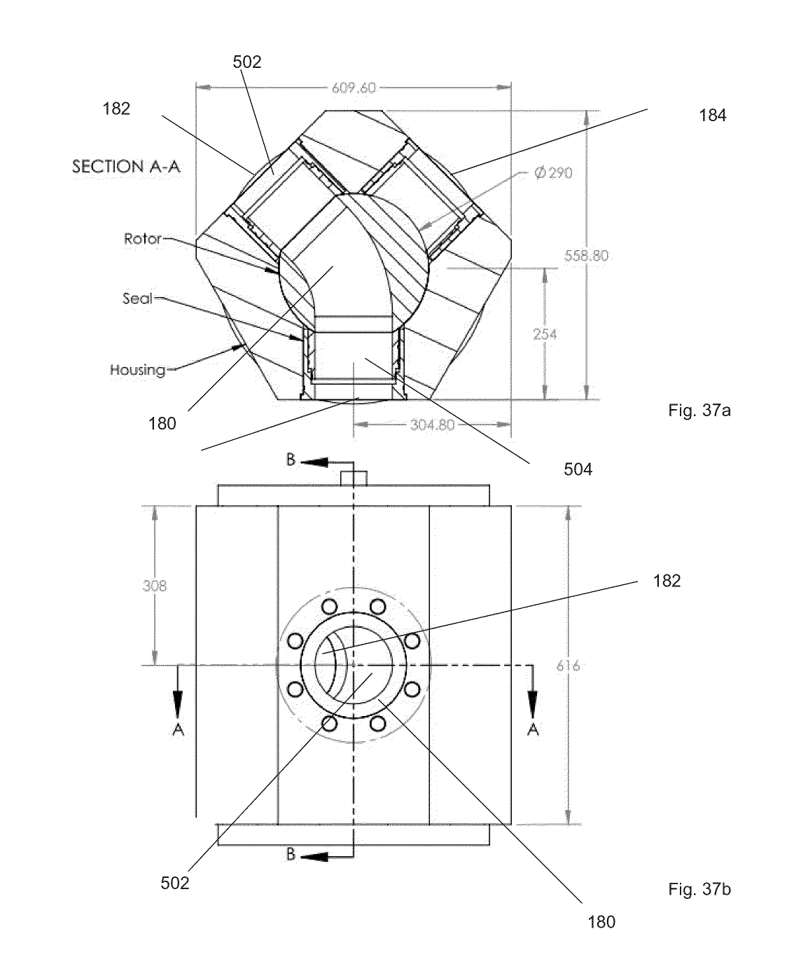

FIG. 37a may be an overhead cutaway view of the valve 100 with the inner rotor 200 being align in a position to connect a first port 180 to a second port 182. FIG. 37b may be an illustration of the inner port 502 being aligned with the first port 180 wherein the second port 182 may be in communication with the first port 180.

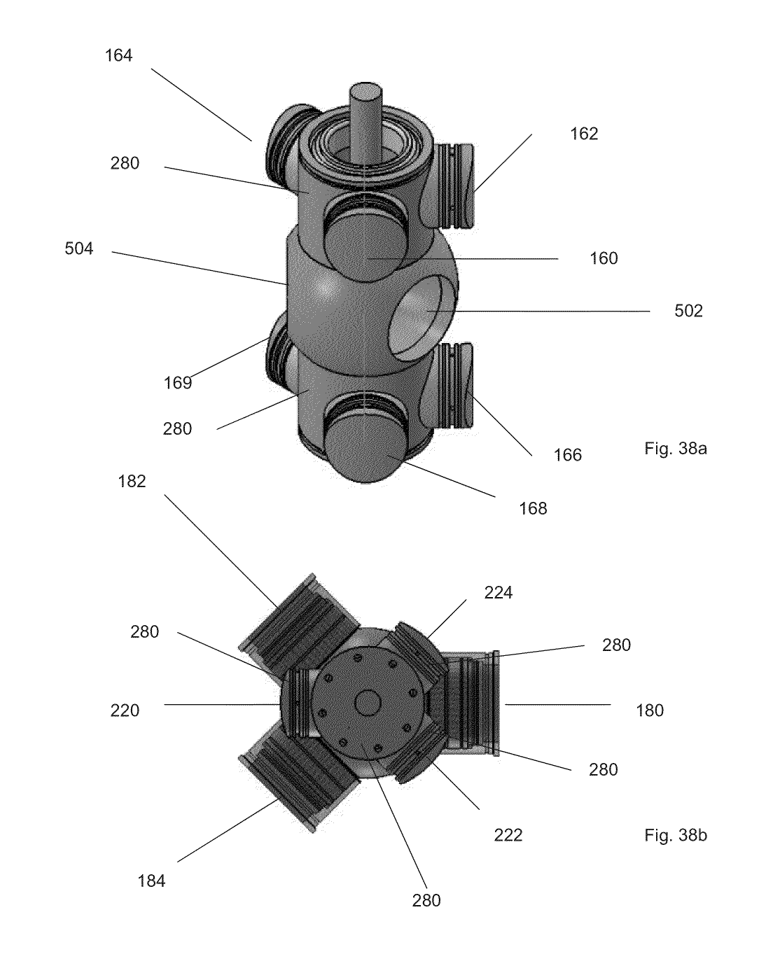

FIG. 38a may be an illustration of the inner rotor 200 with a first opening 502 and a second opening 504. It also may illustrate how cylindrical pressure balancing seals 160 may be used to stabilize the inner tube 200 and to offer offsetting pressure to keep the pressure on the bearings 192 198 at a reasonable level. FIG. 38b may be an overhead view of the inner rotor 200 with the cylindrical pressure balancing seals 160 being placed opposite the openings 180, 182 and 184. For example, when orifice 184 has pressure, it may also be communicate to the cylindrical pressure balancing seals 160 on the opposite side 224 of the orifice 184.

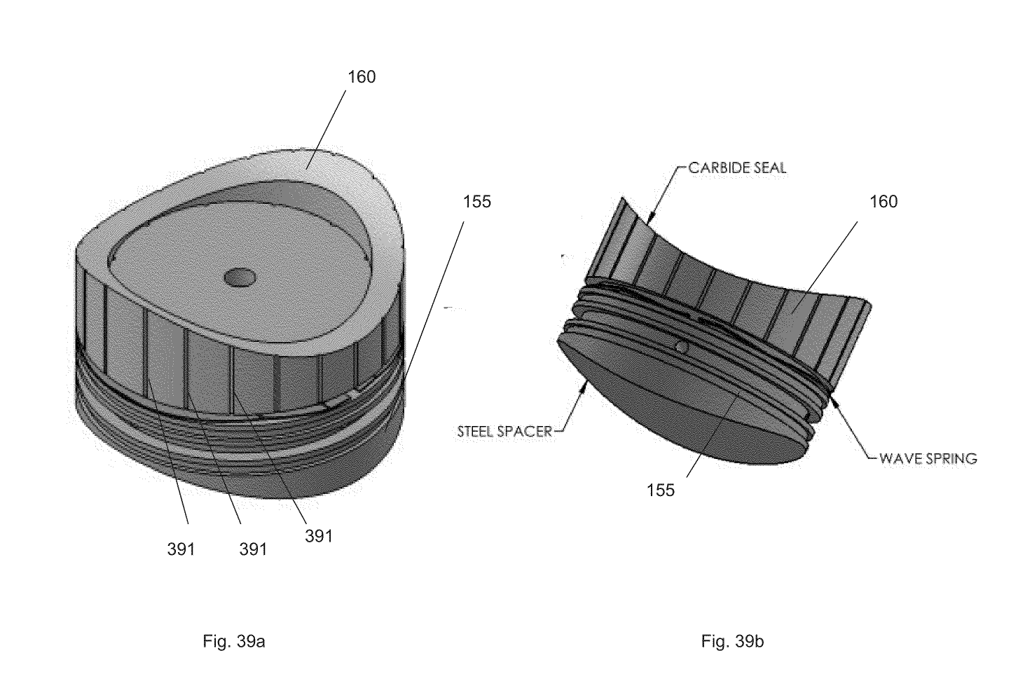

FIGS. 39a and 39b may be more detailed views of the cylindrical pressure balancing seals 160. The cylindrical pressure balancing seals 160 may seal retainers 155. The cylindrical pressure balancing seals 160 may have channels 391 where the pressurized material such as hydraulic fluid may be communicated to the inner rotor 200. The channels 191 may be evenly placed or be in any other advantageous pattern. The size of the channels 191 may vary depending on the pressuring material being used.

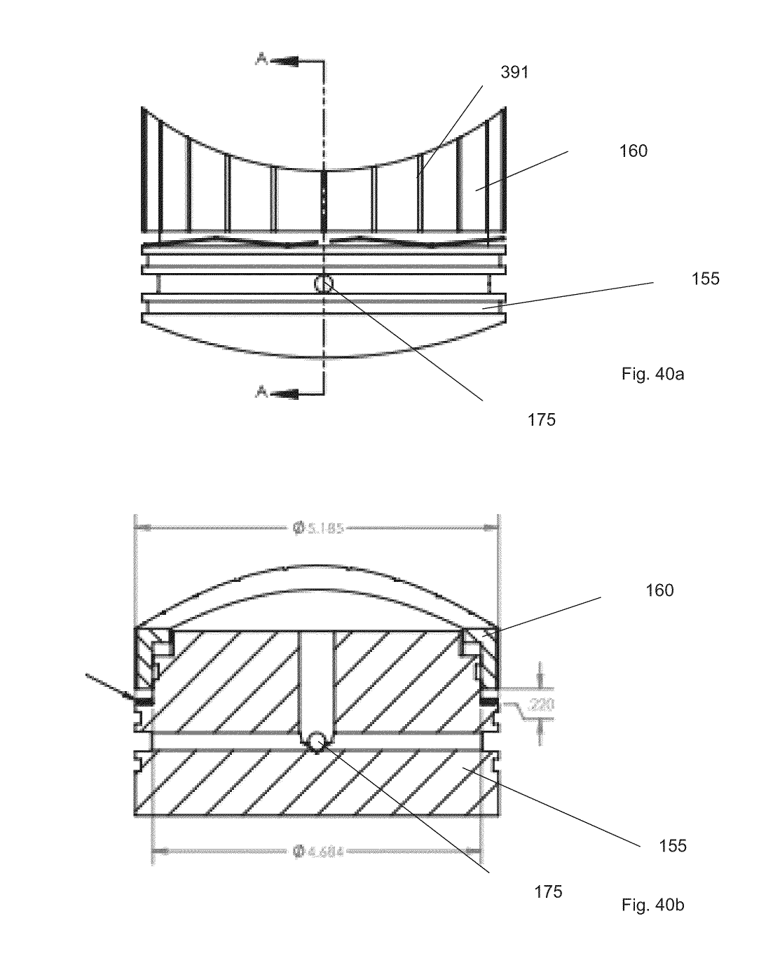

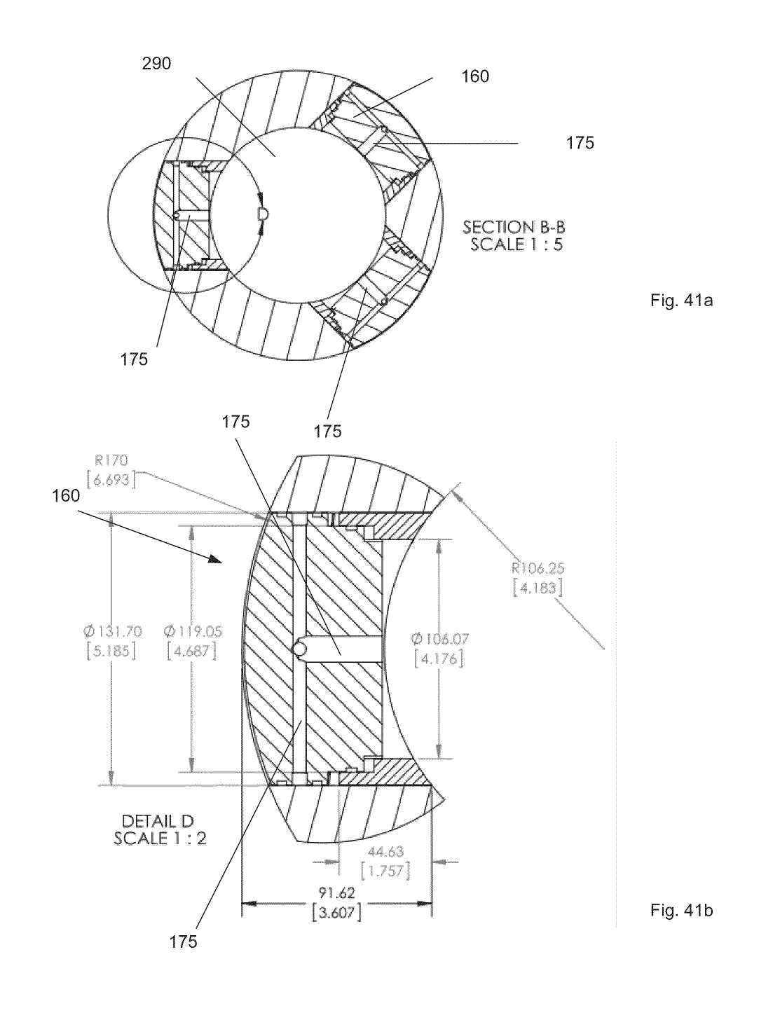

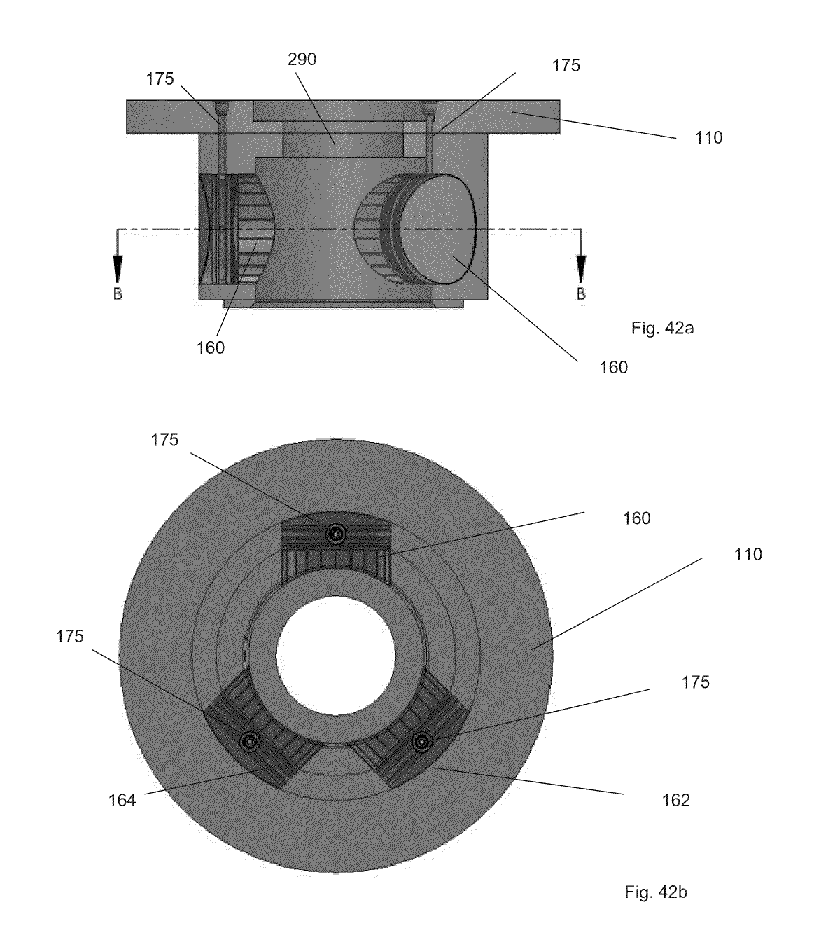

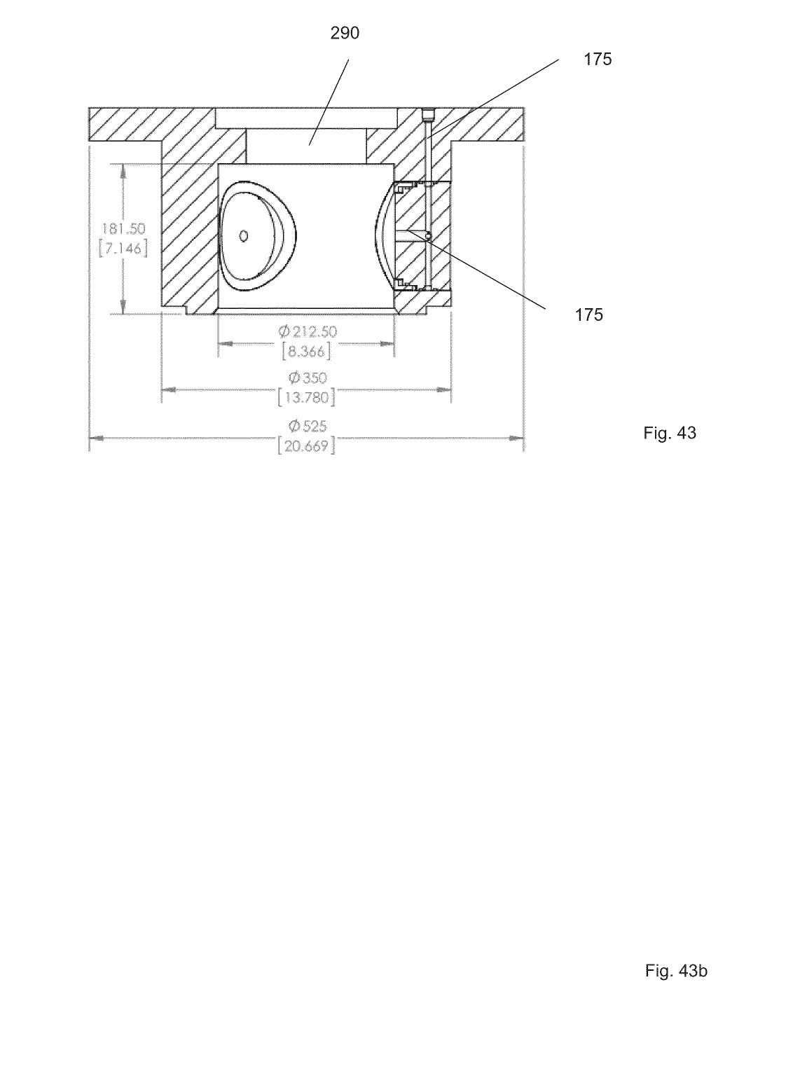

FIGS. 40a and 40b may be additional illustrations of the cylindrical pressure balancing seal 160, including the seal retainer 155. The pressure carrying channels 175 may also be visible and the channels may communicate pressurized material to the channels 391. FIGS. 41a and 41b may be cutaway illustrations of the cylindrical pressure balancing seals 160 with the pressure communication paths 175 illustrated. FIGS. 42a and 42b see through views of the cylindrical pressure balancing seals 160 in place as part of a cap 162 to seal the inner rotor 200 to the outer body 110. Also, the pressure communication channels 175 may also be viewed to understand how the pressure may be passed to the proper cylindrical pressure balancing seal 160. Finally, FIG. 43 may be a cutaway illustration of the cap 162 with the spindle 290, the cylindrical pressure balancing seal 160 and the pressure communication channels 175 illustrated.

The disclosed rotary ceramic valve 100 may be superior to previous valves in a variety of ways. In one aspect, the rotary ceramic tube valve 100 may have a ceramic coating applied to the inner surface 120 of the outer tube 110 and to the outer surface 210 of the inner ported cylinder 200. As a result, friction among the surfaces of the rotary ceramic valve 100 will be lower, leading to easier use of the valve 100 and longer life. Further, the tolerances between the outer tube 110 and the ported rotor 200 can be extremely tight as the fiction between the coated surfaces will be so low. Further, the concept of using pressure to balance the stress on the inner rotor 200 and the related equipment may allow the valve 100 to be used in situation involving great pressure and force.

Further, inner rotor 200 may also have cylindrical pressure balancing seals 160 and related pressure communicating paths 175 that provide counterforce to reduce stress on the bearings. A first orifice 180 on a first side may communicate pressure to a cylindrical pressure balancing seal opposite the first side 164 and 169. Similarly, a second orifice 182 on a second side may communicate pressure to a cylindrical pressure balancing seals 160 and 168 opposite the second side and a third orifice 184 on a third side may communicate pressure to a cylindrical pressure balancing seals opposite the third side 162 and 166. As a result, as pressure is controlled by the turning rotor 200, equal pressure may be applied to the opposite side of the rotor 200 using the pressure communicating channels and the cylindrical pressure balancing seals 160 and pressure on the rotor 200 is reduced producing a more reliable and longer lifetime value 100.

1. A rotary ceramic valve comprising:
An outer body wherein the shell comprises:
a plurality of outer orifices that correspond to inner orifices in an inner cylinder;
a seal seat adapted accept a seal wherein the seal separates chambers inside the tube;
a first bearing seat adapted to accept a first bearing for the inner cylinder;
a second bearing seat adapted to accept a second bearing for the inner cylinder;
a first closure adapted to seal a first end of the outer tube; and
a second closure adapted to seal a second end of the outer tube and adapted permit a turning apparatus to protrude to allow the inner cylinder to be rotated; and
wherein an inner surface of the outer tube comprises a ceramic coating;
An inner rotor comprising:
a plurality of inner ports that correspond to outer orifices in the outer body; and
a spindle that corresponds to the first bearing and second bearing and is in communication with the turning apparatus adapted to turn the inner cylinder; and
wherein the outer surface of the inner cylinder comprises a ceramic coating; and
Pressure balancing apparatus wherein the pressure balancing apparatus comprises pressure balancing seals and pressure communicating paths wherein the pressure balancing apparatus is adapted to take pressure from a first side of the inner rotor and communicate the pressure to a second side of the inner rotor wherein the first side is opposite the second side.

2. The rotary ceramic valve of claim 1, wherein the outer orifices comprise:
A first orifice facing a first plane;
A second orifice facing a second plane; and
A third orifice facing a third plane.

3. The inner cylinder of claim 2, wherein the rotor comprises:
A first cylinder port facing the first plane;
A second cylinder port facing the second plane;
Wherein the rotor may be rotated and
wherein aligning the first orifice and first cylinder port also aligns the second orifice and the second cylinder port.

4. The rotary ceramic valve of claim 3, wherein aligning the third orifice and the third cylinder port also aligned the second orifice with the second cylinder port.

5. The rotary ceramic valve of claim 1, wherein
if the first orifice and first cylinder port are not aligned, the first orifice is closed;
if the second orifice and second cylinder port are not aligned, the second orifice is closed; and
if the third orifice and third cylinder port are not aligned, the third orifice is closed.

6. The rotary ceramic valve of claim 1 wherein the inner ported rotor comprises an oval shape and the outer body comprises a cavity that is complementary to the inner ported rotor.

7. The rotary ceramic valve of claim 6, wherein the seals in the outer body are a complementary shape to the inner ported rotor.

8. The rotary ceramic valve of claim 1, wherein a portion of the inner ported cylinder not connected to the inner ports is removed.

9. The pressure balancing apparatus further comprising trunnions wherein the trunnions comprise the pressuring balancing ports to receive the communicated pressure and wherein trunnions are in communication with the inner rotor.
